(19) United States
(12) Patent Application Publication
(10) Pub. No.: US 2026/0228957 A1
(43) Pub. Date: Aug. 6, 2026

(54) OUT-OF-CORE RENDERING

(71) Applicant: Autodesk, Inc., San Francisco, CA (US)

(72) Inventors: Haik Horst Lorenz, Langenzersdorf (AT); Henrik Buchholz, Michendorf (DE); Sebastian Dunkel, Troisdorf (DE); Eric O'Connell, Portland, OR (US)

(21) Appl. No.: 19/043,363

(22) Filed: Jan. 31, 2025

(51) Int. Cl. G06T 15/00; G06T 15/08; G06T 17/00

(52) U.S. Cl. CPC G06T 15/005; G06T 15/08; G06T 17/00

(57) ABSTRACT

Methods, systems, and apparatus, including medium-encoded computer program products for rendering objects for display include: maintaining, by a computer having a display device and a local memory, a data structure in the local memory; receiving, by the computer, a request to render a current frame for display on the display device; sequentially determining, by the computer, nodes of a first set of current nodes that are associated with the current frame and that are already included in the data structure; in response to the determining, updating the data structure; and rendering, by the computer, the current frame for display on the display device based on the updated data structure.

### BACKGROUND

This specification relates to visualization of three-dimensional models on client devices. Further, this specification relates to model data used in computer graphics applications, such as computer-generated animation and/or computer visualization systems and techniques.

### SUMMARY

Some techniques described in this specification relate to rendering objects of a 3D model on a display device that take into consideration a viewpoint of the user when viewing the 3D model. When objects of the 3D model are to be rendered, the nodes of a bounding volume hierarchy (BVH) generated for the 3D model can be traversed when rendering at least some objects. Some techniques described in this specification relate to constructing the BVH that, when traversed, facilitates the rendering of the objects of the 3D model on the display device. Some techniques described in this specification relate to populating a cache in a memory of the display device that stores the nodes of the BVH, where the population of the cache is performed during the traversing of nodes of the BVH so that objects of the 3D model are rendered. By maintaining a subset of the nodes of the BVH corresponding to objects to be rendered, the cache makes it possible for the rendering to be practically achieved without the need to store the whole 3D model in the memory, e.g., even when the whole 3D model is too large to fit entirely into the memory.

In general, a first aspect of the subject matter described in this specification can be embodied in one or more methods (and also one or more non-transitory computer-readable mediums tangibly encoding a computer program operable to cause data processing apparatus to perform operations), including: obtaining, by a computer having a display device and a local memory, a bounding volume hierarchy including nodes corresponding to a plurality of objects in a three-dimensional, 3D, model of an environment, wherein the bounding volume hierarchy distributes the plurality of objects into the nodes based on spatial partitioning of the 3D model, and wherein objects of the nodes are ranked in a descending order of sizes from a root node of the bounding volume hierarchy to leaf nodes of the bounding volume hierarchy; initiating, by the computer, a queue data structure in the local memory of the computer; traversing, by the computer, the bounding volume hierarchy to add one or more nodes of the nodes of the bounding volume hierarchy to the queue data structure, wherein objects of the one or more nodes are to be rendered on the display device of the computer, and wherein the traversing of the bounding volume hierarchy stops when objects of one or more other nodes of the bounding volume hierarchy that are not added to the queue data structure (i) are not visible from a current viewpoint for a user within the environment or (ii) have screen space sizes that do not satisfy a predetermined threshold screen space size; and rendering, by the computer, the objects of the one or more nodes on the display device.

In a second aspect, a BVH can be build according to one or more methods including: obtaining, by a computer, a sorted list of a plurality of objects in a three-dimensional, 3D, model of an environment, wherein the sorted list includes the plurality of objects in descending order of sizes; determining, by the computer, a root node cut-off diameter based on one or more objects included in the sorted list; generating, by the computer, a root node of the bounding volume hierarchy, the root node corresponding to a root node bounding volume enclosing one or more objects that are located in one or more beginning positions of the sorted list, wherein a number of the one or more objects enclosed in the root node bounding volume is dependent on the root node cut-off diameter; determining, by the computer, a child node cut-off diameter based on remaining objects in the plurality of objects that are included in the sorted list and that are not enclosed by the root node bounding volume; and generating, by the computer, one or more child nodes of the root node to be included in the bounding volume hierarchy, wherein each of the one or more child nodes corresponds to a child node bounding volume enclosing one or more objects that is determined from the remaining objects in the plurality of objects in the 3D model based on applying a spatial splitting function, wherein a number of the one or more objects enclosed in each child node bounding volume is dependent on the child node cut-off diameter.

In a third aspect, a computer implemented method can be provided that includes: maintaining, by a computer having a display device and a local memory, a data structure in the local memory, the data structure storing nodes in a BVH, the nodes corresponding to a plurality of objects in a three-dimensional, 3D, model of the environment; receiving, by the computer, a request to render a current frame for display on the display device; sequentially determining, by the computer, nodes of a first set of current nodes that are associated with the current frame and that are already included in the data structure, wherein the first set of current nodes comprises a first node and a second node that is determined after the first node; in response to the determining, updating the data structure such that i) the first node is placed at an insertion position of the data structure and ii) after the first node is placed at the beginning position, the second node that is determined after the first node is placed at a position of the data structure that immediately follows the insertion position; and rendering, by the computer, the current frame for display on the display device based on the updated data structure. In some instances, the BVH can be the BVH that is built according to the method of the second aspect.

In some instances, the BVH can be built for a given 3D model of an environment, where the BVH can be traversed according to the method as described in the first aspect. During traversing, a data structure with nodes of the BVH can be generated, such as the queue data structure that is built by adding the nodes of the BVH during the traversal. In the queue data structure, each node of the BVH is stored in association with a priority value, which is dependent on a size of one or more objects that correspond to the node of the BVH. In some instances, the nodes of the queue data structure can be processed and added, in accordance with a descending order of their respective priority values, to a list data structure that can be maintained in the local memory and used when processing a request to render a current frame for display on a display device as described in relation to the method of the third aspect.

By utilizing the described BVH traversal techniques to traverse the nodes in a BVH that corresponds to a 3D model as part of a graphics rendering process, the following advantages are achieved. By initializing a priority queue with a root node of the BVH and adding node of the BVH to the priority queue at each traversal step of the traversal algorithm, a computer can perform processing of model data of a large 3D model (e.g., a 3D model that has a very large number of geometric primitives associated with the objects included in the 3D model) more efficiently without requiring the model data to completely reside in the main memory of the computer. As such, the rendering of the 3D model can be performed with less computational resources based on traversing a BVH structure to generate a priority queue for use to determine an order for rendering objects of the 3D model that has a relatively small memory footprint (requiring less storage space compared to that needed for the model data of the 3D model).

Based on techniques of the present disclosure, objects of a 3D model representing a 3D environment can be rendered for display on a display device of a computer with reduced latency (e.g., reduced loading time, rendering time, or both) and improved responsiveness to user viewpoint changes with regard to the 3D model when viewed in a user interface (e.g., virtual interface of a virtual reality device) provided on the display device. For example, every time a user is associated with repositioning (e.g., by detecting a move or association with another location within the 3D model) into a new viewpoint within the 3D model in the user interface, a new rendered view of a scene of the 3D model that corresponds to the new viewpoint can be generated more quickly relative to another rendering process that uses different technique for the rendering that does not make use of a priority queue or another data structure.

The described BVH traversal techniques also achieve improved data efficiency when utilized to traverse the nodes in the BVH as part of a graphics rendering process. A linked list that is used by the described BVH traversal techniques to facilitate the BVH traversal has a limited memory footprint and therefore does not consume excessive memory space. Thus, it requires fewer memory resources to store nodes of the BVH relative to another technique that may makes use of a data structure as a cache for the nodes. When traversing the BVH, by updating the linked list to place the most recently requested node in the beginning position of the linked list and removing the least recently requested nodes from the linked list, the described BVH traversal techniques can traverse a larger BVH that corresponds to a larger 3D model relative to another BVH traversal technique, despite that the same amount of memory space is utilized.

When the described BVH traversal techniques are implemented on a mobile device or another computer device with limited computational resources (e.g., processor resources, memory resources, or both), out-of-memory crashes caused by the rendering of the objects from the 3D model can be avoided. The described BVH traversal techniques can thus improve the overall smoothness of the graphics rendering process by making more efficient use of the limited computational resources of the computer. Further, the described BVH traversal techniques can improve an experience of a viewer of the rendered scenes of the 3D model.

By utilizing the described BVH construction techniques to build a BVH that corresponds to a 3D model, the following advantages are achieved. A BVH built using the described BVH construction techniques stores a reference to a bounding volume that encloses a different subset of the objects of the 3D model in each node of the BVH, i.e., including the root node, leaf nodes, and any non-leaf nodes in between the root node and leaf nodes. Such a structure allows the BVH to be traversed faster while still having a moderate number of objects per node (i.e., with the bounding volume corresponding to each node). For example, a BVH for a 3D model that is built using the described BVH construction techniques can be traversed, as part of a graphics rendering process, with a much smaller number of traversal steps relative to traversing, as part of the same graphics rendering process, another BVH built for the same 3D model in which objects are only represented by the leaf nodes of the BVH.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to support visualization of large models in accordance with the implementations of the present disclosure.

FIG. 2 shows an example of a process for traversing a bounding volume hierarchy (BVH) in accordance with implementations of the present disclosure.

FIG. 3 shows an example of a process for performing a traversal iteration in accordance with implementations of the present disclosure.

FIGS. 4A and 4B show examples of a BVH and examples of a priority queue, respectively.

FIGS. 5 and 6 show an example of a process for building a BVH in accordance with implementations of the present disclosure.

FIG. 7 shows an example illustration of operations performed to build a BVH in accordance with implementations of the present disclosure.

FIG. 8 shows an example of a process for rendering a current frame for display on a display device in accordance with implementations of the present disclosure.

FIG. 9 shows an example of sub-operations of one of the operations in the process shown in FIG. 8.

FIG. 10 shows another example illustration of operations performed to update a linked list in accordance with implementations of the present disclosure.

FIG. 11 shows an example of sub-operations of another one of the operations in the process shown in FIG. 8.

FIG. 12 shows another example illustration of operations performed to update a linked list in accordance with implementations of the present disclosure.

FIG. 13 is a schematic diagram of a data processing system including a data processing apparatus, which can be programmed as a client or as a server.

Like reference numbers and designations in the various drawings indicate like elements.

### DETAILED DESCRIPTION

The present disclosure describes various tools and techniques for rendering objects of a three-dimensional (3D) model that are to be displayed on a display device. The described techniques support stable performance for the rendering (e.g., by reducing the likelihood of out-of-memory crashes at the display device due to overloading from processing large data portions). In accordance with the implementations of the present disclosure, objects can be rendered progressively while a user navigates within a 3D model of an environment. In some implementations, the rendering can be performed in a virtual reality (VR) environment or an augmented reality (AR) environment, as well as a combination of those where different users can render and interact with a model through different devices.

In some implementations, the 3D models can be rendered from different devices or platforms, including desktop devices, mobile devices (e.g., smart phones or tablets), VR and/or AR devices, among other examples. Computer graphics applications include different software products and/or services that support generation of representations of 3D objects that can be used for visualization of object models, for animation and video rendering, in the context of video games, or other contexts. Computer graphics applications also include computer animation programs showing views or scenes during user reviews and navigation inside or outside of a model.

In some cases, 3D computer visualizations can be created in a variety of scenarios and in the context of different technologies. For example, 3D models of objects such as manufacturing sites, buildings, physical constructions, or other large-scale structures can be animated for display on user interfaces of native device applications, web applications, VR applications, or AR applications, among other examples. User devices can display such user interfaces where objects of 3D models are rendered.

In accordance with the implementations of the present disclosure, an application (e.g., a client or user interface application running on a user device) can be configured to renders different objects of a 3D model to be displayed while a user moves within different regions of an environment (e.g., a VR environment) that includes the 3D model. The application can be configured to perform the real time rendering of a large 3D model to provide a smooth and flexible workflow when rendering objects with reduced likelihoods of out-of-memory crashes or rendering dropouts. In some instances, a user may request to display at least a portion of a 3D model in the context of navigating within a 3D environment displayed in a user interface of an application running on a user device (e.g., a mobile device, a VR device, or other). The model that is to be rendered may be a large model that requires a lot of computational resources (such as memory and processing capacity of the rendering device) to load and be rendered in full (or to a larger extent). As such, rendering the model may impose some challenges for execution on a user device that does not have the resources needed for the large model loading or for use cases that require the large model to be loaded and rendered quickly, e.g., within a defined time frame such as one or two seconds or even milliseconds. For example, 3D models can be very large (e.g., can have millions or billions of objects, and have even a greater number of, e.g., billions or trillions of, geometric primitives associated with the objects) where even a high-end personal computer with multiple graphical processing units could not manage to load the model without a delay in time. The user devices that can be used to load a model may have limitations to their loading limits that can affect the user experience when rendering scenes of a 3D model representing a virtual environment. Thus, rendering objects of a large model can be associated with technical challenges of providing poor rendering performance including unexpected interruption of the operation of the application, delayed rendering of portion of the model, and device downtime (e.g., caused by buffer overflow).

People can use different user interface applications to navigate in a 3D space in real time and change their viewpoint when viewing portions of a 3D model rendered within the 3D space. When an application is started on a user device, a user can be associated with a location and origination within the 3D space and with regard to a 3D model. A viewpoint can be any given point in the 3D space, for example, an eye, or camera perspective. For example, a viewpoint can be initially outside of the 3D model, for example, outside of a model of a building, where based on interaction and repositioning of a user in relation to the model, the viewpoint can be changed and the building can be viewed from a closer distance or from within, e.g., within a particular room or floor of the building. At each step of changing the viewpoint of a user, different objects of the 3D model can be relevant for the rendering.

In accordance with the present implementations, different objects of the 3D model can be dynamically rendered for display on a display device as a user moves (e.g., changes position) within the 3D space where the 3D model is rendered. In some instances, by utilizing the described BVH traversal techniques to traverse the nodes in a BVH that corresponds to the 3D model as part of a graphics rendering process, the objects of the 3D model can be rendered more quickly in response to changes of user's viewpoint in relation to the model with an improved generated frames per second (FPS) and reduced likelihood of rendering dropout, e.g., missing triangles or other geometric primitives.

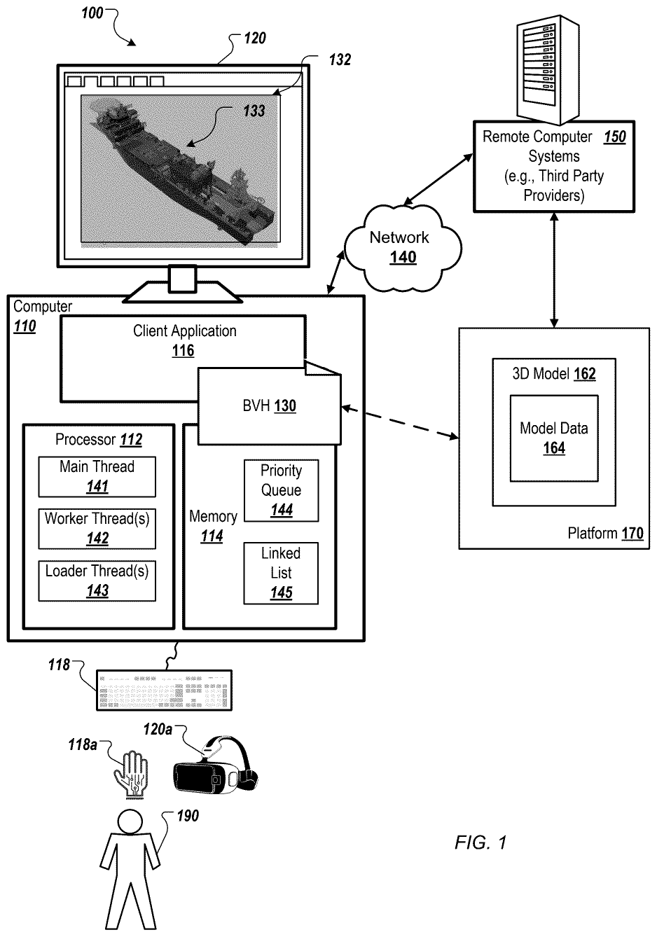

FIG. 1 shows an example of a system 100 usable to support visualization of models without size limitations for the models in a more time-efficient and more computational resource-efficient manner by using the priority-based rendering strategy in accordance with implementations of the present disclosure. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including VR programs, AR programs, video games, or design interaction applications which support view exploration and collaboration, among other examples.

The computer 110 includes a client application 116 that includes implemented logic to help users involve in rendering and navigating within a 3D model 162 of an environment. In some implementations, a user 190 can interact with the client application 116 to initiate or join an already initiated virtual world (a computer-generated representation of a physical world, such as an interior space of a house, a representing a collaboration space, other) to navigate within the space (e.g., virtual environment) and view the model from different aspects.

For example, the client application 116 can be groupware designed to support the user 190 in a collaboration process with another user that uses another client application, where both users navigate within the 3D model 162. For example, the client application 116 can be used by the user 190 to intentionally navigate into the 3D model to show various aspects of the model that can be rendered at another client application of another user (e.g., viewed from another viewpoint in the 3D model as specified for the other user). For example, that can be part of a collaborative design process between a design user using the client application 116 to navigate within a construction project and a stakeholder of the construction project that is presented with a view of the model from outside and inside in different level of detail. In some instances, the client application 116 can provide software functionality to facilitate collaborative processes between connected devices for a shared view of the 3D model of the environment. In accordance with the present implementations, rendering of certain objects from models that are both visible from the viewpoint and that are sufficiently large in size (e.g., that have sizes that satisfy a predetermined threshold size) can be prioritized over remaining objects from models that are either invisible from the viewpoint (e.g., due to obstruction) or too small in size to become noticeable (e.g., that have sizes that fail to satisfy the predetermined threshold size).

The client application 116 can run locally on the computer 110, remotely on a computer of one or more remote computer systems 150 (e.g., one or more third party providers' one or more server systems accessible by the computer 110 via the network 140) or both locally and remotely. In some implementations, the client application 116 can be an access point for accessing services running on a platform 170 that support rendering of model data 164 stored on the platform 170.

For example, the model data 164 can include geometric primitives associated with objects included in the 3D model 162 that is stored on the platform 170. In some implementations, the geometric primitives can take on a variety of shapes, e.g., triangle, polygon, higher-order surface, sphere, line, or another geometric structure. In some implementations, the geometric primitives can define surfaces of the objects included in the 3D model 162.

In some implementations, the platform 170 can be a cloud platform implemented as one or more computers in one or more locations that can be accessed by the computer 110 to support cloud services (such as the visualization services that can be implemented as part of the platform 170) that relate to data visualization in different display modes and can support tools and techniques to interact with the data to navigate in a display mode.

In some implementations, the computer 110 can impose restrictions on the amount of data that can be processed and rendered when 3D models that are to be rendered are large and take long periods of time (e.g., a minute or two) to load. In some cases, the rendering of large volumes of data can be delayed or even the memory of the computer 110 can crash if the loading operations overwhelm the capacities of the computer to process and render a lot of objects. Such problem can be alleviated by implementing the priority-based rendering techniques that, at each frame, prioritize for rendering of objects that are both visible from the viewpoint and that are sufficiently large in size to be provided to a display device 120 for display at the frame, in accordance with implementations of the present disclosure. By using such rendering techniques, objects from a particular scene within a field of view of a user within the model can be prioritized and filtered to determine a subset of objects that are to be downloaded, loaded, and/or rendered. Also, such techniques can support stable rendering performance at the user device that improves the user experience and is considerate to the memory capacity of the device.

In accordance with the present implementations, the client application 116 can request to render a 3D model, e.g., such as the 3D model 162 provided by the platform 170, where the model is too large to fit in-memory of the computer 110 while still having the resources to maintain rendering of objects of the 3Dmodel at a satisfactory frame rate, e.g., a frame rate that is comfortable for an end user. For example, the frame rate can be maintained at above 24, 25, or 30, e.g., in a range between 30 and 75, between 40 and 60, around 60, and so on.

The frame rate is a frame generation rate that measures how quickly a number of frames appears within a period of time (e.g., a second). Hence the frame rate may also be referred to as the generated FPS rate. The frame rate can be computed based on the formula: 1/(the amount of time taken to render the visible model objects and execute the logic of the client application 116 relative to the latest frame provided to the display device 120 for display). The frame generation rate is distinct from the screen refresh rate for the display device 120, since the screen refresh rate is fixed for the device, and the frame generation rate can vary and loading and rendering of objects can be adjusted to match the frame generation rate and to improve the performance of the rendering by efficiently utilizing the device resources so that the frame generation rate matches the device's frame rate. In some implementations, the applied techniques improve the performance of the client application 116 to support the requested rendering even in cases where 3D models are large models that include many objects.

In accordance with implementations of the present disclosure, the processor 112 can execute multiple threads simultaneously, i.e., either at different processor cores of the processor 112 or at a same processor core of the processor 112, to provide high throughput execution of the client application 116 while maintaining power and time savings. In addition to power and time savings, multi-thread execution may further lead to more efficient use of processor resources and improved processor performance, as resources are less likely to sit idle with multiple threads operating in different stages of execution of the logic implemented by the client application 116.

As illustrated in FIG. 1, the multiple threads that can be scheduled for execution on the processor 112 include a main thread 141, one or more worker threads 142, and one or more loader threads 143. Each thread may include a set of instructions that execute independently of instructions from another thread. For example, each thread may include a set of instructions that correspond to a subset of the logic implemented by the client application 116. In some implementations, the one or more worker threads 142 can be part of a worker thread pool that includes a pool of worker threads. Analogously, in some implementations, the one or more loader threads 143 can be part of a loader thread pool that includes a pool of loader threads.

In some implementations, when the client application 116 is used to render objects of the 3D model 162 on the display 120, the client application 116 can obtain a bounding volume hierarchy (BVH) 130 generated for the 3D model 162, e.g., obtained from the platform 170 or from an external storage. For example, the platform 170 or the external storage can store the BVH 130 in association with the 3D model 162, e.g., either as part of or separate from the model data 164. The BVH 130 is a data structure that includes nodes corresponding to a plurality of objects in the 3D model 162.

The client application 116 can download the BVH 130 to the computer 110 and traverse the BVH 130 to determine which objects of the 3D model 162 to render. The BVH 130 is a tree data structure which serves as a spatial index of the 3D model 162. For example, the BVH 130 can take the form of a binary tree or a quad tree. This spatial index accelerates the operations performed at the computer 110 involved in the rendering of the objects from the 3D model 162, including the core operation of ray tracing. Ray tracing involves a technique for the discovery of intersections between rays and geometric primitives to determine the visibility of an object (e.g., a geometric primitive) from a viewpoint of a user.

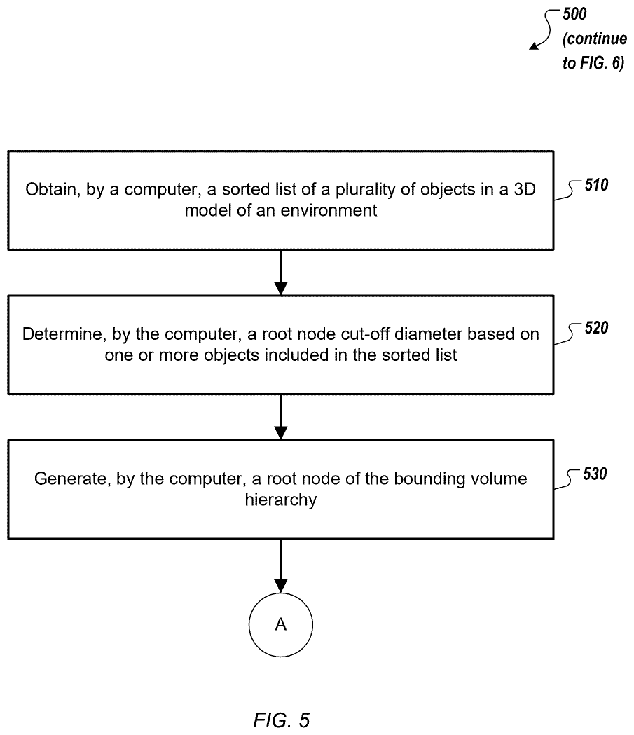

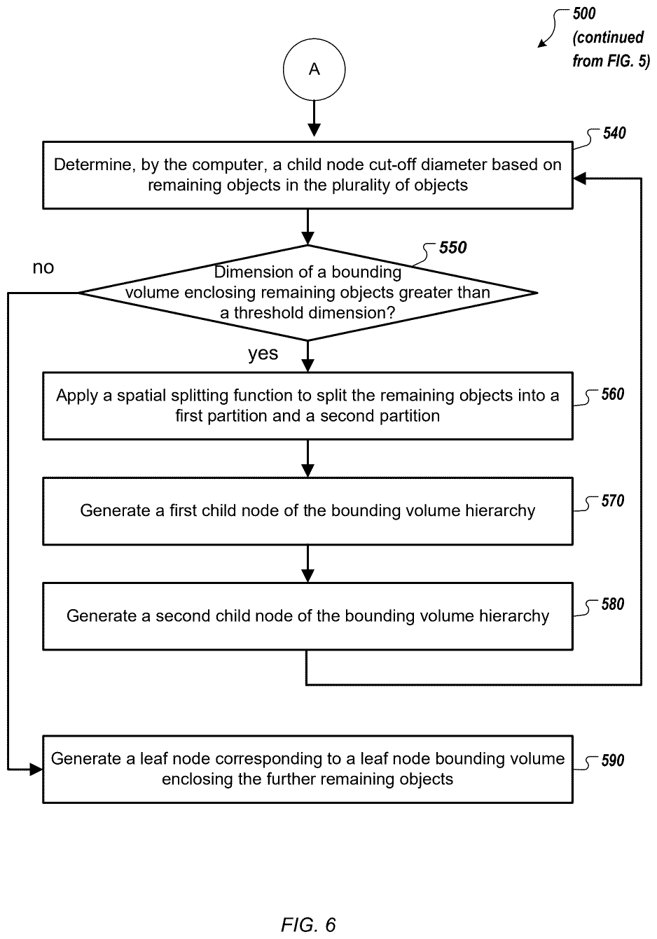

In some implementations, the BVH 130 can be built for the 3D model 162, for example, at the platform 170 or at an external component or services. In some instances, the BVH 130 can be built according to implemented logic that is in accordance with geometric primitives associated with the objects of the 3D model 162. The BVH 130 can be built to include a plurality of nodes corresponding to objects of the 3D model, e.g., as described in more detail in relation to FIGS. 5, 6, and 7. The BVH 130 bounds geometry of the 3D model in a hierarchical fashion. More specifically, each node of the BVH 130 represents a bounding volume, which encloses one or more objects of the 3D model. The BVH 130 hierarchically adds nodes moving away from the root node toward the leaf nodes of the BVH 130 by defining objects enclosed in successively smaller bounding volumes. To that end, in some implementations, each node can store a reference to a corresponding bounding volume, or one or more objects enclosed by the corresponding bounding volume. In addition to the corresponding bounding volume, each node can store a reference to each child node of the node. For example, the reference can be either an index or a pointer to a child node. In some implementations, the BVH 130 can be built based on performing process 500 described below with reference to FIGS. 5-7.

In accordance with the present implementations, the BVH 130 that can be generated, e.g., by the platform 170 or other service, can store a reference to a bounding volume that encloses a different, non-overlapping subset of the objects of the 3D model 162 in each node of the BVH, i.e., including the root node, leaf nodes, and any non-leaf nodes in between the root node and leaf nodes. Put another way, the BVH 130 that can be generated can include N nodes that correspond respectively to N spatially distinct, non-overlapping bounding volumes of the environment. This is in contrast to some other BVHs that can enclose objects of the 3D model only in the bounding volumes that are represented by the leaf nodes of the BVH, i.e., and not the other nodes of the tree. For example, a BVH could include leaf nodes that represent bounding volumes associated with single objects, and the parent node of two or more leaf nodes could represent bounding volumes that enclose each of the objects represented by the two or more leaf nodes; the root node could represent a bounding volume that is a union set of bounding volumes represented by all other nodes of the BVH and that encloses every object represented by the BVH.

In accordance with implementations of the present disclosure, the client application 116 can utilize multiple data structures in the memory 114 during the operation of the client application 116. That is, multiple data structures will be allocated in the memory 114 to support the processing of the data of the BVH 130. For example, in operation, the memory 114 can allocate multiple data structures to store data used by the multiple threads executed by the processor 112 for traversing the BVH 130. As illustrated in FIG. 1, the multiple data structures can include a priority queue 144 and a linked list 145 to be used when processing the BVH 130.

The priority queue 144 is a data structure in which each data element (also referred to as “element,” “entry,” or “data item”) of the priority queue has a priority or priority value associated with it. Data elements can be added, or enqueued, onto the priority queue 144 in an arbitrary order. Data elements can also be removed, or dequeued, from the priority queue 144 based on their priority values. In accordance with implementations of the present disclosure, the data elements stored in the priority queue 144 can include nodes of the BVH 130. For example, each data element stored in the priority queue 144 can be a respective node of the BVH 130.

The linked list 145 is a data structure that includes a collection of data elements (also referred to as “elements,” “entries,” or “data items”) that represent a sequence of data elements where, each data element of the linked list 145 includes a link to a next data element in the sequence. In this manner, each data element in the linked list 145 points to at least one other data element in the list. Typically, the data elements are equal in size. A head pointer is added to the first data element of the sequence and is used to identify the first data element in the linked list 145. In implementations, the first data element in the linked list 145 points to the second data element, which in turn points to the third data element, and so on. Data elements may be added to or removed from the head of the linked list 145, the tail of the linked list 145, or within the linked list 145. In accordance with implementations of the present disclosure, the data elements stored in the linked list 145 can include nodes of the BVH 130. For example, each data element stored in the linked list 145 can be a respective node of the BVH 130.

In some implementations, the client application 116 can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a smart phone or a tablet computer (e.g., a touch screen can be an input/output device 118, 120). Moreover, the computer 110 can include or be part of a VR or AR system. For example, the input/output devices 118, and 120 can include a VR/AR input controllers, gloves, or other hand manipulating tools 118a, and/or a VR/AR headset 120a.

In some implementations, the input/output devices can include hand-tracking devices that are based on sensors that track movement and recreate interaction as if performed with a physical input device. In some implementations, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc. The VR and or AR devices, either connected to the computer 110 or being standalone devices that integrate a computer (with processor and memory) and can communicate with the platform 170 and immerse users connected through these devices into a virtual environment where 3D models of objects can be presented in a simulated real-life physical environment (or substantially similar environment) and users navigate within the environment and are presented with different visual objects.

In some implementations, the user 190 can cause the computer 110 to render a view 133 of the 3D model 162 that is presented on a user interface 132 of the display device 120 and visually shows how an avatar of the user 190 (or another user) interacts with the view, wherein the view is generated based on processing the BVH 130 for the 3D model 162. The display device 120 can render a particular view of the 3D model 162 while the user 190 is navigating within the 3D model 162 and is changing his position within the 3D space. In some implementations, the user 190 can be provided with the view 133 as a presentation of a view of the 3D model 162 via VR devices or other AR devices, where the user's view of the model on the user interface 132 can change while the user is navigating in and interacting with the model. For example, the view 133 can change based on user interaction with the interface 132 to move the user closer to the 3D model 162.

In accordance with implementations of the present disclosure, the rendering of the 3D model 162 and at least some of the objects of the 3D model 162 can be performed based on a priority-based rendering strategy, in accordance with a viewpoint of the user (including the position and orientation of the user). Utilizing the priority-based rendering strategy, the computer 110 can generate a priority queue that stores nodes corresponding to objects to be rendered for display based on ranking objects according to the sizes and visibility of the objects (e.g., where the ranking is performed based on the BVH 130) and a limit of the rendering capacity of the computer 110.

The systems and techniques described herein are applicable to any suitable application environment that can graphically render any portion of an environment, including the objects therein. Thus, in some implementations, model data from 3D models stored on the platform 170 can be used for rendering objects in different modes and accessed from multiple types of devices, where a user can navigate within the virtual environment where the model is rendered.

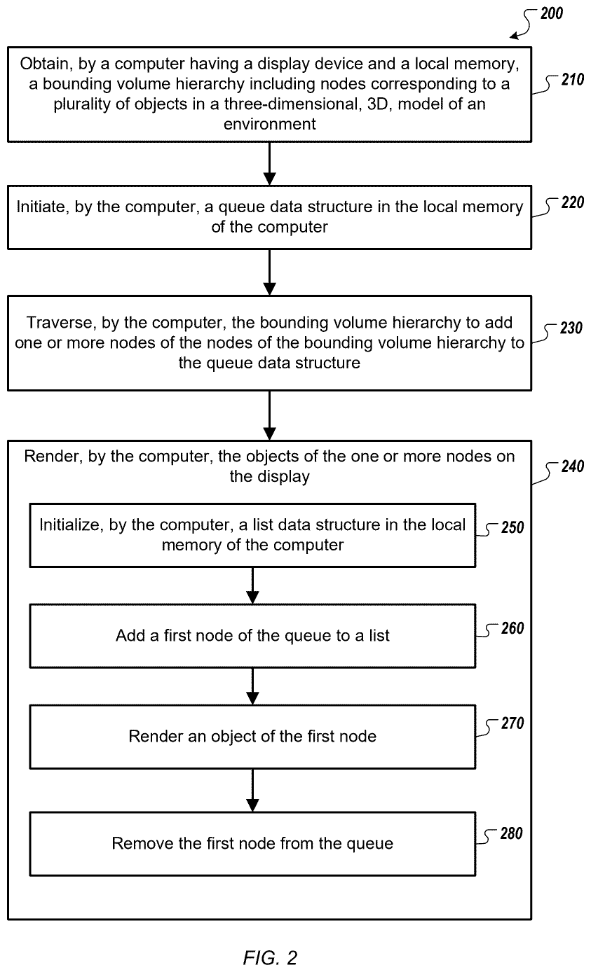

FIG. 2 shows an example of a process 200 for traversing a BVH in accordance with implementations of the present disclosure. In some implementations, the process 200 can be performed by a computer that has a display device and local memory, e.g., the computer 110 of FIG. 1, to facilitate the rendering of model data, e.g., the model data 164 of FIG. 1, stored on a platform, e.g., the platform 170 of FIG. 1, while a user operates the computer to navigate around and within a three-dimensional, 3D, model of an environment, e.g., the 3D model 162 of FIG. 1. For example, the 3D model can be a 3D model of a manufacturing site, building, physical construction, or another large-scale structure.

In general, the process 200 can be repeatedly performed by the computer to dynamically render objects for display on a display device as the user moves within the environment and changes their viewpoint within the environment. For a current viewpoint of the user within the environment, the process 200 can performed to render a subset of the objects included in the environment display on the display device based on the current viewpoint.

For example, every time the computer obtains an indication that user has changed to a new viewpoint within the environment different from the current viewpoint, the computer can perform an iteration of the process 200, which includes initiating a new priority queue data structure in the local memory of the computer and traversing the BVH to add different nodes of the BVH to the new queue data structure.

In some implementations, 3D models can be generated and used for rendering in various contexts. In some implementations, a user can generate, create, or upload a model of a physical entity or environment that includes various objects and space organization. The generated 3D models can be provided by a platform (e.g., the 3D model 162 from the platform 170 of FIG. 1) and can be accessible through various access points, such as different user interfaces that can be accessed via desktop devices, mobile devices, other devices, services, or other entities.

In some implementations, navigation within the 3D model can be in the context of user interaction in an architecture information modeling application. For example, the 3D model can be a digital representation of physical and functional characteristics of a building or other structure and can be created using building information modeling application. The 3D model includes a representation of a building design as a combination of building objects. An object is an element of the building such as, for example, a slab, a wall, a column, a door, or a void-space, (e.g., a shape of a room).

In some implementations, navigation within the 3D model can be in the context of user interaction in a video game. For example, when a game is built, created objects and scenes are used to generate three-dimensional models that can be defined for different layout levels and based on script gameplan.

In some implementation, the digital representation of the building or the game may be accessed from the computer for rendering the rendering can be in a virtual 3D model environment within which an avatar of the user is positioned. For example, a model of a building or a game can be built to include tiles that can be dynamically loaded while the user moves within the building or plays the game on the computer. The 3D model of the building or the game is rendered, and if the model is a large model, the rendering of the model in full can be a time consuming and a resource expensive task. The model loading may not be possible to be performed within the memory of the computer, for example, the computer can be of a mobile device that does not natively support heavy computations and large data storage.

With the increasing complexity and the size of a 3D model, the scalability to render the model can decline and affect the performance and the user experience during the rendering. Cases where the complexity of models is growing and rendering of data can be costly and hardware restricted may require considerations for optimization of the loading and unloading of objects. In some implementations, when a model of a building or a game is rendered, it may not be necessary that all the objects are initially loaded but rather the loading and rendering can be optimized and dynamically adjusted to the position of the user in the environment.

At 210, a BVH is obtained (received or generated) by the computer. For example, the BVH can correspond to the BVH 130 of FIG. 1. The BVH is a data structure that includes nodes corresponding to a plurality of objects in the 3D model of the environment. The BVH distributes the plurality of objects into the nodes in the BVH based on spatial partitioning of the 3D model. That is, the BVH includes a plurality of nodes. Each node corresponds to a bounding volume that encloses a different subset of the plurality of objects in the 3D model of the environment. Each subset includes at least one, but fewer than all, of the nodes of the BVH. The “bounding volume” can be of any appropriate geometry, for example, a bounding box, sphere, ellipsoid, cylinder, rectangle, discrete oriented polytype, convex hull, or another geometry. One or more objects being “enclosed” by a bounding volume means that the one or more objects are either in part (e.g., more than a threshold percentage, e.g., more than 50%, more than 75%, more than 90%, and so on) or in whole surrounded by a boundary of the bounding volume.

Within the BVH, the objects of the nodes are ranked in a descending order of sizes from a root node of the BVH to leaf nodes of the BVH. Thus, an object that corresponds to a parent node in the BVH will have a larger size than an object that corresponds to a child node of the parent node in the BVH. For example, the size can be defined as an actual size (e.g., height, width, depth, dimension, or thickness) of the object in the real world. As another example, the size can be defined as a screen size of the object (e.g., the number of screen pixels that the object covers) when the object is displayed on the display device.

The BVH is obtained at the computer that is a user device used for rendering the 3D model. For example, the BVH is obtained for the 3D model when a user of the computer initiates opening of the 3D model. In some cases, the 3D model can be stored in the local memory of the computer. In other cases, the 3D model can be stored on a remote computer system, for example, at a platform such as the platform 170 of FIG. 1.

In some cases, the BVH can be received by the computer from a remote computer system, for example, from a platform such as the platform 170 of FIG. 1, and then stored in the local memory of the computer. In other words, in these cases, the BVH is generated remotely at the remote computer system and provided to the computer over a network, e.g., the network 140 of FIG. 1. For example, the obtaining can include streaming of the BVH from the other computer and/or through a service. The other computer from which the BVH is obtained may or may not be the same as the remote computer system where the 3D model is stored.

In other cases, the BVH can be generated locally by the computer based on the 3D model. For example, the generation of the BVH can be performed at the computer or can be invoked from an external service (e.g., a cloud service) that can generate the BVH based on model data for the 3D model.

At 220, a priority queue is initiated by the computer in the local memory of the computer. That is, the computer allocates space in the local memory for a priority queue that will be used to store the nodes of the BVH. A priority queue is a data structure in which each data element (each node of the BVH) added to the priority queue has a priority or priority value associated with it. Data elements (nodes of the BVH) can be added, or enqueued, onto the priority queue in arbitrary order and are removed, or dequeued, from the priority queue based on their priority values.

At 230, the BVH is traversed by the computer in order to add one or more nodes of the nodes of the BVH to the priority queue. The priority queue is used by the computer to guide the traversal of the BVH. That is, the objects that correspond to the one or more nodes that have been added to the BVH are not necessarily the objects to be rendered on the display device of the computer. Instead, the objects that correspond to the one or more nodes that have been added from the priority queue to a linked list (in operation 240, as discussed below) are the objects to be actually rendered on the display device of the computer.

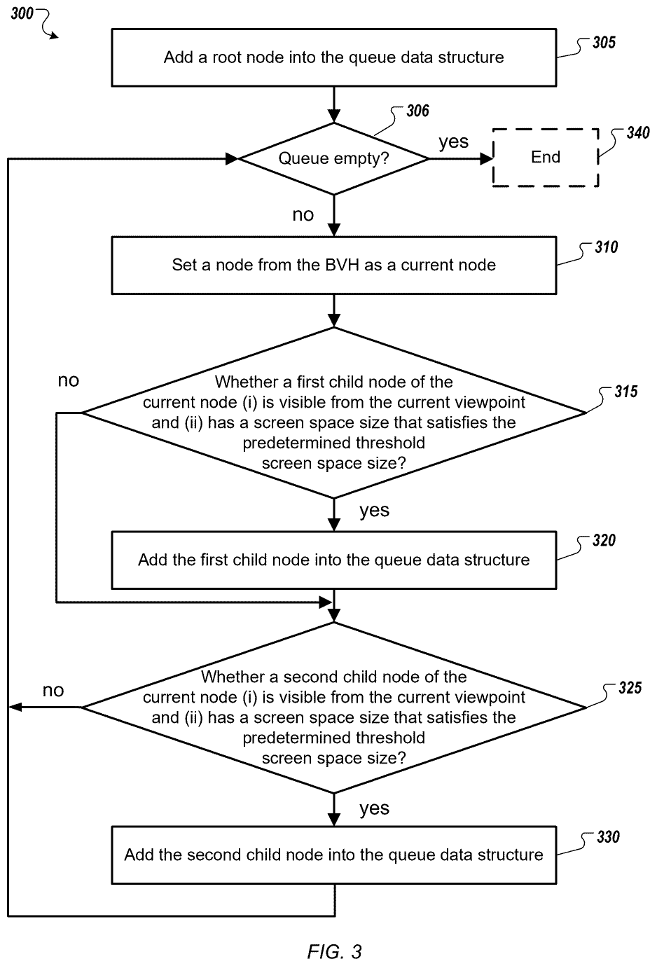

The traversal of the BVH to add the one or more nodes of the nodes of the BVH to the priority queue can include traversing the BVH across a plurality of iterations. At each iteration, the computer adds but fewer than all of the nodes of the BVH to the priority queue. In some cases, no node of the BVH is added to the priority queue at an iteration. For example, a traversed node may not be added to the priority queue when objects corresponding to both child nodes of the currently traversed node are too small to satisfy a screen space size threshold (e.g., predefined, user provider, or dynamically determined, among other examples). The traversal of the BVH ends when objects of one or more other nodes of the BVH that are not yet added to the priority queue either (i) are not visible from the current viewpoint of the user within the environment or (ii) have sizes that do not satisfy a predetermined threshold size, or both (i) and (ii). Operation 230 is explained further below with reference to FIG. 3.

At 240, the objects that are enclosed by the bounding volumes represented by the one or more nodes are rendered by the computer on the display device based on the current viewpoint of the user within the environment. That is, the computer obtains the portion of the model data corresponding to the objects that are enclosed by the bounding volumes represented by the one or more nodes, and then applies any of a variety of rendering algorithms or techniques to the obtained portion of the model data. The objects include a proper subset of the plurality of the objects that correspond to the nodes of the BVH. For example, the portion of the model data can include geometric primitives, e.g., triangles or rectangles, associated with objects that are enclosed by the bounding volumes represented by the one or more nodes and that are included in the 3D model that is stored on the platform.

The geometric primitive data can be rendered using any of a variety of computer graphics algorithm. For example, geometric primitive data can be rendered by using a ray tracing algorithm, which is a rendering technique that simulates the path of light in a scene to create highly realistic images with accurate reflections, shadows, and lighting effects. As another example, geometric primitive data can be rendered by using a rasterization algorithm, which is a rendering algorithm that renders 3D objects by painting pixels on the screen based on their position in the scene.

In some cases where a portion of the model data is locally available, it can be directly obtained by the computer from the local memory and then rendered to the display device. In some other cases, the model data is stored in the remote computer system and can be downloaded by the computer from the remote computer system to the local memory, and then the objects that correspond to the downloaded portion of the model data can be rendered by the computer from the local memory to the display device. In yet cases where some of the portion of the model data is locally available, while others of the portion of the model data is stored in the remote computer system, the computer can obtain some of the portion of the model data from the local memory, while downloading others of the portion of the model data from the remote computer system.

In this regard, the traversal of the BVH at 230 may also end when the portion of the model data that corresponds to the nodes that have already been added to and stored in the priority queue exceeds a predetermined threshold size (e.g., predefined for the display device). In some instances, the predetermined threshold size can be determined based on a nominal capacity of the local memory of the computer, or can be obtained as a user defined property.

Thus, for example, when the total amount of the geometric primitive data that has been downloaded by the computer from the remote computer system exceeds the nominal capacity of the local memory of the computer, the traversal of the BVH at 230 may also end, even when the BVH has nodes corresponding objects that are visible from the current viewpoint yet to be added to the priority queue.

Operation 240 includes sub-operations 250-280, as discussed below. At 250, a linked list is initiated by the computer in the local memory of the computer. That is, the computer allocates space in the local memory for a linked list that will be used to store the nodes of the priority queue. A linked list is a data structure that includes a collection of data elements (a collection of nodes of the priority queue) that represent a sequence and, for each data element (a node of the priority queue), a link to the next data element (another node of the priority queue) in the sequence. In this manner, each data element in the linked list points to at least one other data element in the list.

At 260, a node of the priority queue is added by the computer to the linked list in the local memory. The nodes of the priority queues can be added to the linked list in accordance with a descending order of their respective priority values. For any node, its priority value is dependent on a size of the one or more objects that are enclosed by the bounding volume represented by the respective node. That is, the computer selects, from the priority queue, the node that has the largest priority value among all nodes currently stored in the priority queue, and then adds the selected node that has the largest priority value to the linked list.

At 270, one or more objects that correspond to the node added to the linked list are rendered by the computer on the display device. That is, the computer obtains the portion of the model data corresponding to the one or more objects that are enclosed by the bounding volume represented by the node added to the linked list, and then applies any of a variety of rendering algorithms/techniques to the obtained portion of the model data. For example, the portion of the model data can include geometric primitives, e.g., triangles or rectangles, associated with objects that are enclosed by the bounding volumes represented by the added node.

At 280, after the one or more objects that corresponds to the node have been rendered on the display device, the node is removed by the computer from the priority queue. The removed nodes have been added to the linked list. The objects that correspond to the nodes in the linked list are rendered by the computer for display on the display device.

In general, iterations of sub-operations 260-280 can be repeatedly performed as part of operation 240. In particular, the computer can repeatedly perform sub-operations 260-280 corresponding to operation 240 to render the objects for display on the display device insofar as the priority queue is not empty, i.e., insofar as at least one node is stored in the priority queue. If the priority queue is empty, then the operation 240 and, corresponding, the process 200 ends.

Despite being illustrated as being performed sequentially, in implementations, operations 230 and 240 can be performed substantially in parallel. That is, the traversal of the BVH to add one or more nodes of the nodes of the BVH to the priority queue can substantially overlap the rendering of the objects that correspond to the nodes that have been added (from the BVH) to the linked list. For example, an iteration of the sub-operations 260-280 of operation 240 can be performed in parallel with an iteration of the traversal of the BVH, e.g., after operation 310 of FIG. 3. As mentioned previously, a node may be removed from the priority queue after it has been added to the linked list. In practice, this means that, at any time during operation 230, the priority queue may, and generally will, not store all of the nodes the objects corresponding to which are to be rendered.

By performing operation 230 to traverse the BVH and operation 240 (which in turn includes sub-operations 250-280) to render the objects in this manner, the computer effectively decouples the BVH traversal process from the rendering process. With operation 230 decoupled from operation 240, they can each be executed at their own respective cadence or paces. While traversal of the BVH more than once per frame may not be useful, it would be possible to render multiple frames with the same set of nodes. For example, nominal changes in viewpoint rarely make for significant changes in the set objects to be rendered for display. Thus, in practice, one traversal of the BVH every 2-5 frames would be acceptable in some cases. Furthermore, decoupling operation 230 from operation 240 also reduces processor workload because the two operations can run on different threads to more evenly distribute the load across different processor cores of the processor. From another aspect operations 230 and 240 can be performed more quickly than if both operations 230 and 240 are running on the same processor core.

FIG. 3 is a flow diagram of an example process 300 for traversing the BVH to add the one or more nodes of the nodes of the BVH to the priority queue. For convenience, the process 300 will be described as being performed by a computer. For example, the computer 110 of FIG. 1, appropriately programmed in accordance with this specification, can perform the process 300. Each iteration in the plurality of iterations included in the traversal of the BVH (that is performed as part of operation 230 of FIG. 2) involves performing at least some of the operations included in the process 300.

At 305, the computer adds a root node of the BVH into the priority queue. That is, the priority queue is initialized with the root node of the BVH, and the plurality of iterations included in the traversal of the BVH begin with an initial iteration where the root node of the BVH is added into the priority queue.

At 306, the computer checks whether the priority queue is empty. That is, the computer determines whether there is at least one node stored in the priority queue. In response to determining that the priority queue is not empty, i.e., there is at least one node stored in the priority queue, the process 300 proceeds from 306 to 310. Alternatively, in response to determining that the priority queue is empty, i.e., there is no node stored in the priority queue, the process 300 proceeds from 306 to 340.

At 310, the computer sets a node from the BVH as a current node for the iteration included in the traversal of the BVH. In general, the current node can be any node of the BVH that has not been previously added to the priority queue. At the initial iteration, the current node can be the root node. At any further subsequent iteration, the current node can be any node which has already been processed by the computer during the traversal of the BVH, e.g., already added into the priority queue in a preceding iteration. In some implementations, the nodes of the BVH are added to the priority queue in accordance with a descending order of their hierarchy in the BVH across the plurality of iterations, such that a node of the BVH that corresponds to a larger bounding volume will be added before another node of the BVH that corresponds to a smaller bounding volume.

At 315, the computer determines, for a first (e.g., left) child node of the current node of the BVH, whether one or more objects that correspond to the first child node (i) are visible from the current viewpoint of the user and (ii) have a size that satisfies (e.g., is no smaller than) a predetermined threshold size.

For example, the size can be defined as an actual size (e.g., height, width, depth, dimension, or thickness) of the one or more objects in the real world. As another example, the size can be defined as a screen size of the one or more objects (e.g., the number of screen pixels that the objects cover) when the objects are displayed on the display device.

In some implementations, the visibility of the one or more objects that correspond to the first child node can be determined by the actual computer graphics algorithm that is used by the computer for rendering the geometric primitive data. For example, the visibility can be determined as part of a ray tracing algorithm. As another example, the visibility can be determined as part of a rasterization algorithm.

If yes, that is, if the one or more objects that correspond to the first child node are both visible from the current viewpoint of the user and have a size that satisfies (e.g., is no smaller than) the predetermined threshold size, the process 300 proceeds from 315 to 320. If no, that is, if the one or more objects that correspond to the first child node are either not visible from the current viewpoint of the user, or have a size that fails to satisfy (e.g., is smaller than) the predetermined threshold size, the process 300 proceeds from 310 to 325.

At 320, the first child node of the current node of the BVH is added by the computer to the priority queue that is maintained in the local memory. From 320, the process 300 proceeds to 325.

At 325, the computer determines, for a second (e.g., right) child node of the current node of the BVH, whether one or more objects that correspond to the second child node (i) are visible from the current viewpoint of the user and (ii) have a size that satisfies (e.g., is no smaller than) a predetermined threshold size.

If yes, that is, if the one or more objects that correspond to the second child node are both visible from the current viewpoint of the user and have a size that satisfies (e.g., is no smaller than) the predetermined threshold size, the process 300 proceeds from 325 to 330. If no, that is, if the one or more objects that correspond to the second child node are either not visible from the current viewpoint of the user, or have a size that fails to satisfy (e.g., is smaller than) the predetermined threshold size, the process 300 proceeds returns from 325 to 305.

At 330, the second child node of the current node of the BVH is added by the computer to the priority queue that is maintained in the local memory. From 330, the process 300 returns to 305. In this way, the traversal of the BVH continues. That is, assuming the priority queue is not empty, then another iteration of the traversal of the BVH is performed, and the computer continues to determine whether either a first child node, a second child node, or both child nodes of the child node (which will be set as the current node in the next iteration) of the BVH should be added to the priority queue.

At 340, the process 300 ends. That is, in response to determining that the one or more objects that correspond to the child node are either not visible from the current viewpoint of the user, or have a size that fails to satisfy (e.g., is smaller than) the predetermined threshold size, the traversal of the BVH ends, and thus no more nodes of the BVH will be added to the priority queue.

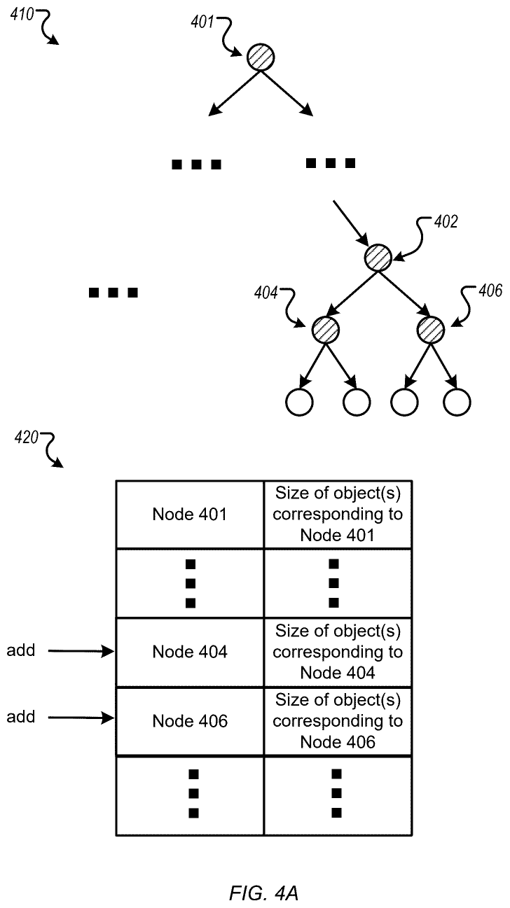

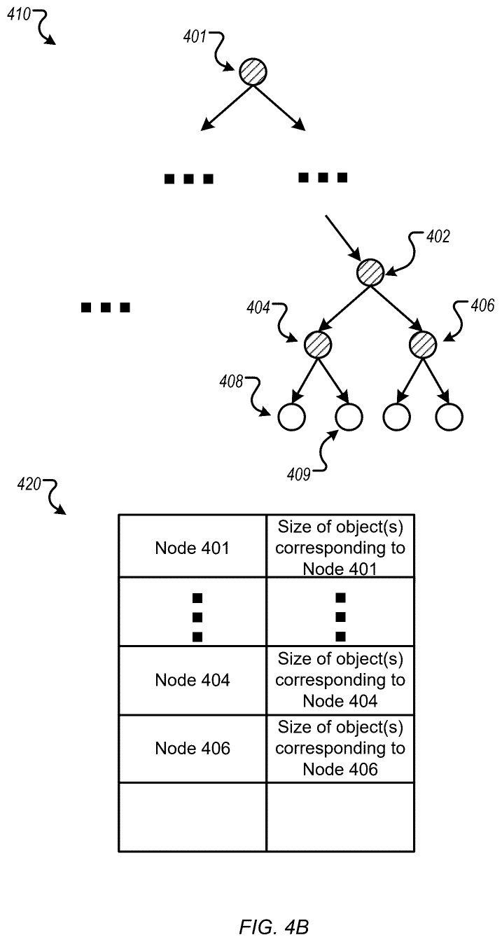

FIG. 4A shows an example of a BVH 410 and an example of a priority queue 420. For example, the priority queue 420 can correspond to the priority queue 144 of FIG. 1. The BVH 410 includes a plurality of nodes corresponding to a plurality of objects in a 3D model of an environment. The plurality of nodes include node 401, 402, node 404, and node 406, where node 401 is the root node of the BVH 410.

In some implementations, the priority queue 420 can be generated to store one or more nodes of the BVH 410 during traversing of the BVH 410. When the priority queue 420 is generated, for each node added to the priority queue 420 based on a traversed node of the BVH 410, a priority value associated with the node is added. The priority value is dependent on a size of the one or more objects that are enclosed by the bounding volume represented by the node. As mentioned previously, the size can be defined as either an actual size or a screen size of the objects.

Suppose that, in the example of FIG. 4A, during a particular iteration of the process 300, the node 402 is the current node. Node 402 can be any intermediate node in the BVH 410. For example, the particular iteration can be any subsequent iteration that is being performed during the traversal of the BVH. In the particular iteration, the computer determines (at 310), for the first child node 404 of the node 402 of the BVH 410, whether one or more objects that correspond to the child node 404 (i) are visible from a current viewpoint of the user and (ii) have a size that satisfies (e.g., is no smaller than) a predetermined threshold size. In response to determining yes, the computer adds (320) the child node 404 to the priority queue 420 and stores, as a new data element in the priority queue, the child node 404 in association with a priority value that is dependent on a size of the one or more objects that correspond to the child node 404.

Analogously, in the particular iteration, the computer determines (310), for the second child node 406 of the node 402 of the BVH 410, whether one or more objects that correspond to the child node 406 (i) are visible from a current viewpoint of the user and (ii) have a size that satisfies (e.g., is no smaller than) a predetermined threshold size. In response to determining yes, the computer adds (320) the child node 406 to the priority queue 420 and stores, as a new data element in the priority queue, the child node 406 in association with a priority value that is dependent on a size of the one or more objects that correspond to the child node 406.

Note that while FIG. 4A illustrates that the root node 401 is stored in the priority queue 420 in association with its priority value (the highest priority value among all data elements stored in the priority queue 420), this may not be the case in practice. In some cases, the root node 401 could have been already removed by the computer from the priority queue 420 by the time the particular iteration is performed, because one or more objects that are enclosed by the bounding volume represented by the root node 401 might have already been rendered by the computer for display.

FIG. 4B shows another example of a BVH 410 and another example of a priority queue 420. Suppose that, in the example of FIG. 4B, during a particular iteration of the process 300, the node 404 is the current node. In the particular iteration, the computer determines (at 310), for the first child node 408 of the node 404 of the BVH 410, whether one or more objects that correspond to the child node 408 (i) are visible from the current viewpoint of the user and (ii) have a size that satisfies (e.g., is no smaller than) a predetermined threshold size. In response to determining no, the computer withholds from adding the child node 408 to the priority queue 420.

Analogously, in the particular iteration, the computer determines (at 310), for the second child node 409 of the node 404 of the BVH 410, whether one or more objects that correspond to the child node 409 (i) are visible from the current viewpoint of the user and (ii) have a size that satisfies (e.g., is no smaller than) a predetermined threshold size. In response to determining no, the computer withholds from adding the child node 409 to the priority queue 420. In the example of FIG. 4B, no further nodes of the BVH 410 have been added to the priority queue 420 during the particular iteration.

FIGS. 5 and 6 show an example of a part of a process 500 for building a BVH in accordance with implementations of the present disclosure. In some implementations, the process 500 can be performed by a computer, e.g., the computer 110 of FIG. 1, based on model data, e.g., obtaining the model data 164 of FIG. 1, of a 3D model of an environment, e.g., the 3D model 162 of FIG. 1 that is stored at an external platform, i.e., platform 170 of FIG. 1. In other implementations, the process 500 can be performed by a platform or a service that includes one or more computers, e.g., the platform 170 of FIG. 1. In some implementations, the 3D model and the model data can be stored at a platform, such as the platform 170 of FIG. 1, where the platform can provide a platform service that performs the process 500 and exposes the built BVH for consumption by an external entity, such as the computer 110 of FIG. 1. In some implementations, the 3D model and the model data can be stored at a platform, such as the platform 170 of FIG. 1, while another service component communicatively coupled to the platform can be configured obtain the model data for the 3D model and execute the process 500 so that a built BVH can be provided for use when rendering at least a portion of the 3D model. For convenience, the process 500 will be described as being performed by a computer.

At 510, a sorted list of a plurality of objects in the 3D model of the environment is obtained (e.g., received or generated) by the computer. The plurality of objects are sorted in a descending order of sizes. Thus, the sorted list begins with an object that has a largest size among the plurality of objects, and ends with an object that that has a smallest size among the plurality of objects. For example, the 3D model can be a representation of a real-world environment and the size of the objects in the 3D model can be defined as an actual size (e.g., height, width, depth, dimension, or thickness) of an object in the real-world environment that corresponds to (as being a representation of) an object in the 3D model. As another example, the size of an object of the 3D model can be defined as a screen size of the object (e.g., the number of screen pixels that the object covers) when the object is displayed on a display device having particular screen characteristics. Another example, the size of an object of the 3D model can be based on, e.g., proportional to or inversely proportional to, a predefined weight. For example, during 3D model creation, the user can manually assign a weight to each object in the 3D model. As another example, the weight could be derived from other object properties, e.g., categories of the objects (e.g., a window object can be assigned a different weight than a door object).

In some cases, the computer can receive the sorted list as-is. For example, the computer can receive the sorted list as an upload from a remote user of the computer over a data communication network, e.g., the network 140 of FIG. 1. As another example, the computer can receive an input from a user specifying which data that is already maintained by the computer or another computer accessibly by the computer should be used as the sorted list, or which data (either maintained by the computer or stored externally) can be accessed and used to generate the sorted list. For example, model data for the 3D model can be stored at a platform or other component (e.g., platform 170 of FIG. 1) and obtained by the computer to be used to generate the sorted list by the computer. In some instances, a platform such as the platform 170 of FIG. 1, can store data for a 3D model, such as the model data 164 for the 3D model 162 of FIG. 1, where the model data can be used to generate the sorted list at the platform to be locally stored and used to build the BVH in accordance with implementations of the present disclosure.

In some instances, the computer can generate the sorted list based on model data (stored at the computer or obtained from an external source) that includes geometric primitives associated with the plurality of objects in the 3D model of the environment. Each object of the plurality of objects in the 3D model of the environment can be associated with a size that can be defined as either an actual size or a screen size, and then the computer can sort the plurality of objects in a descending order of their size to generate the sorted list.

At 520, a root node cut-off diameter is determined by the computer based on one or more objects included in the sorted list. In some implementations, the root node cut-off diameter is determined as a fraction of the size of an object located in a beginning position of the sorted list, i.e., a fraction of the size of the largest object in size in the sorted list. For example, the root node cut-off diameter can be a fraction of (e.g., 1.0, 0.99, 0.9, 0.5, or the like) the size (e.g., the actual size of a real physical object corresponding to the respective object as represented in the 3D model or the screen size of the object when displayed at a particular display device) of the largest object, i.e., the first object in the sorted list.

At 530, a root node of the BVH is generated by the computer. The root node corresponds to a root node bounding volume that encloses one or more objects that are located in one or more positions of the sorted list in a first part of the sorted list (including the beginning position of the sorted list). The exact number of the objects to be enclosed by the root node bounding volume is dependent on the root node cut-off diameter. Generally, because an object needs to have a size that is no smaller than the root node cut-off diameter in order to be enclosed by the root node bounding volume, the smaller the root node cut-off diameter, the greater the number of the objects enclosed by the root node bounding volume. A “root node bounding volume” refers to the bounding volume which the root node of the BVH represents. Analogously, a “child node bounding volume,” which will be discussed below, refers to the bounding volume which a descendent node of the root node of the BVH (an intermediate node or a leaf node of the BVH) represents.

FIG. 6 shows an example of another part of the process 500 for building a BVH in accordance with implementations of the present disclosure. The other part of the process 500 shown in FIG. 6 is a continuation of the part of the process 500 shown in FIG. 5. That is, the other part of the process 500 shown in FIG. 6 is performed after the part of the process 500 shown in FIG. 5 by the computer when building the BVH.

Continuing from 530, at 540, a child node cut-off diameter is determined by the computer based on remaining objects in the plurality of objects that are included in the sorted list and that are not enclosed by the root node bounding volume. In some implementations, the child node cut-off diameter is determined as a fraction of the size of an object located in a position of the sorted list that is immediately subsequent to the positions of the objects which are enclosed by the root node bounding volume. For example, the child node cut-off diameter can be a fraction of (e.g., 1.0, 0.99, 0.9, 0.5, or the like) the size (e.g., the actual size or the screen size) of the that object.

At 550, a dimension of a bounding volume that encloses at least the centers (or centroids) of the remaining objects in the plurality of objects that are included in the sorted list and that are not enclosed by the root node bounding volume is determined by the computer. For example, for bounding volumes that have a spherical geometry, the dimension of the bounding volume can be a diameter of the bounding volume. As another example, for bounding volumes that have a rectangular geometry, the dimension of the bounding volume can be a diagonal dimension or a length of a side of the bounding volume.

The computer determines whether the dimension of the bounding volume is greater than a threshold dimension (e.g., a predefined fixed threshold that may not be dependent on screen size of the objects). For example, the threshold dimension can be 0.1 centimeters, 1 centimeter, 10 centimeters, 50 centimeters, between 0.1 and 20 centimeters, between 1 and 10 centimeters, or the like. In some implementations, the threshold dimension is dependent on a maximum resolution of the display device of the computer. Analogously, in some implementations, the threshold dimension is dependent on the size of the memory or the specifics of other hardware components of the computer. In some implementations, the threshold dimension is a value specified by the user. By checking the dimension of the bounding volumes with respect to a fixed threshold, the splitting of the objects into partitions (as in 560) can be improved by preventing endless recursions where all objects are in a substantially similar location and the spatial splitting cannot be efficiently executed to generate child nodes (as in 570 and 580 below).

If the bounding volume enclosing the remaining objects is greater than the threshold dimension, the process 500 proceeds from 550 to 560. At 560, a spatial splitting function is applied by the computer to split, i.e., spatially partition, the bounding volume that encloses the remaining objects into a first partition and a second partition. The first partition includes a plurality of first remaining objects. The second partition includes a plurality of second remaining objects. The plurality of first remaining objects and the plurality of second remaining objects are different, and, in some cases, non-overlapping objects of the remaining objects in the sorted list. In some implementations, operation 560 can be performed by applying a spatial splitting function to spatially partition the bounding volume along the longest dimension of the bounding volume to generate two smaller partitions: the first partition and the second partition. For example, for bounding volumes that have a rectangular geometry, the longest dimension of the bounding volume can be the longest side (e.g., length) of the bounding volume. In some implementations, the number of geometric primitives associated with the objects enclosed by the first partition is approximately the same as the number of geometric primitives associated with the objects enclosed by the second partition. Examples of suitable spatial splitting functions that can be used by the computer to perform operation 560 include those described in Ernst, Manfred and Greiner, Gunther. “Early Split Clipping for Bounding Volume Hierarchies,” 2007 IEEE Symposium on Interactive Ray Tracing, Ulm, Germany, 2007, pp. 73-78, doi: 10.1109/RT.2007.4342593; and Stich, Martin, Heiko Friedrich, and Andreas Dietrich. “Spatial splits in bounding volume hierarchies.” Proceedings of the Conference on High Performance Graphics 2009. 2009.

At 570, a first child node of the BVH is generated by the computer. The first child node corresponds to a first child node bounding volume that encloses a subset of the plurality of first remaining objects of the first partition. The exact number of the nodes to be included in the subset, and therefore, enclosed by the first child node bounding volume, is dependent on the child node cut-off diameter when applied to bounding volume of the first partition and can vary from case to case. Generally, because an object needs to have a size that is no smaller than the child node cut-off diameter in order to be enclosed by the first child node bounding volume, the smaller the child node cut-off diameter, the greater the subset, i.e., the greater the number of the objects will be included in the subset.

In various cases, however, not all of the plurality of first remaining objects will be included in the subset. This is because the inclusion of more of the nodes in the plurality of first remaining objects will cause the diameter of the first child node bounding volume to fall below the child node cut-off diameter. In other words, in some cases, the subset is a proper subset of the plurality of first remaining objects.

At 580, a second child node of the BVH is generated by the computer. The second child node corresponds to a second child node bounding volume that encloses a subset of the plurality of second remaining objects of the second partition. Much like the first child node bounding volume, the exact number of the nodes to be included in the subset, and therefore, enclosed by the second child node bounding volume, is dependent on the child node cut-off diameter when applied to a bounding volume of the second partition and can vary from case to case. Generally, because an object needs to have a size that is no smaller than the child node cut-off diameter in order to be enclosed by the second child node bounding volume, the smaller the child node cut-off diameter, the greater the subset, i.e., the greater the number of the objects will be included in the subset.

In various cases, however, not all of the plurality of second remaining objects will be included in the subset. This is because the inclusion of more of the nodes in the plurality of second remaining objects will cause the diameter of the second child node bounding volume to fall below the child node cut-off diameter. In other words, in some cases, the subset is a proper subset of the plurality of second remaining objects.

From 580, the process 500 returns to 540. That is, the computer continues to perform another iteration of the other part of the process 500 shown in FIG. 6 to continue to build the BVH. At each iteration, the process can determine a child node cut-off diameter that is relevant for the remaining objects that are part of the plurality of objects that are included in the sorted list and that are not enclosed by the root node bounding volume or any child node bounding volume that was previously generated.

For example, during a first iteration of the part of the process 500 shown in FIG. 6, the first child node can be the left child node of the root node of the BVH, and the second child node can be the right child node of the root node of the BVH. In this example, the root node is a parent node of both the first child node and the second child node.

As another example, during a second iteration of the part of the process 500 shown in FIG. 6, the first child node can be the left child node of the left child node of the root node of the BVH, and the second child node can be the right child node of the left child node of the root node of the BVH. In this example, the first child node and the second child are grandchild nodes of the root node of the BVH. Iterations of the part of the process 500 shown in FIG. 6 can repeat in that order, until no further remaining objects are included in the sorted list, at which time the process 500 will end.

Alternatively, at 550, if the bounding volume is less than the threshold dimension as determined at 550, the process 500 proceeds from 550 to 590. Further alternatively, the process 500 will also proceed from 550 to 590 if the number of objects is smaller than a fixed threshold number. The number threshold can be dynamically determined based on various aspects. For example, a lower number makes the BVH more fine-grained, which is useful for rendering on less powerful computers. On the other hand, a higher number allows for rendering of a larger number of objects at once, which may be preferred when implemented on more powerful computers.

At 590, one or more leaf nodes of the BVH are generated by the computer. In some implementations, the computer generates the one or more leaf nodes by setting the one or more child nodes that have been previously generated by the computer during the iterations of the process 500 as the leaf nodes. That is, the system adds no further child nodes to those child nodes of the BVH. After 590, the process 500 ends, and the computer finishes building the BVH. That is, no further iterations of the process 500 will be performed after 590.

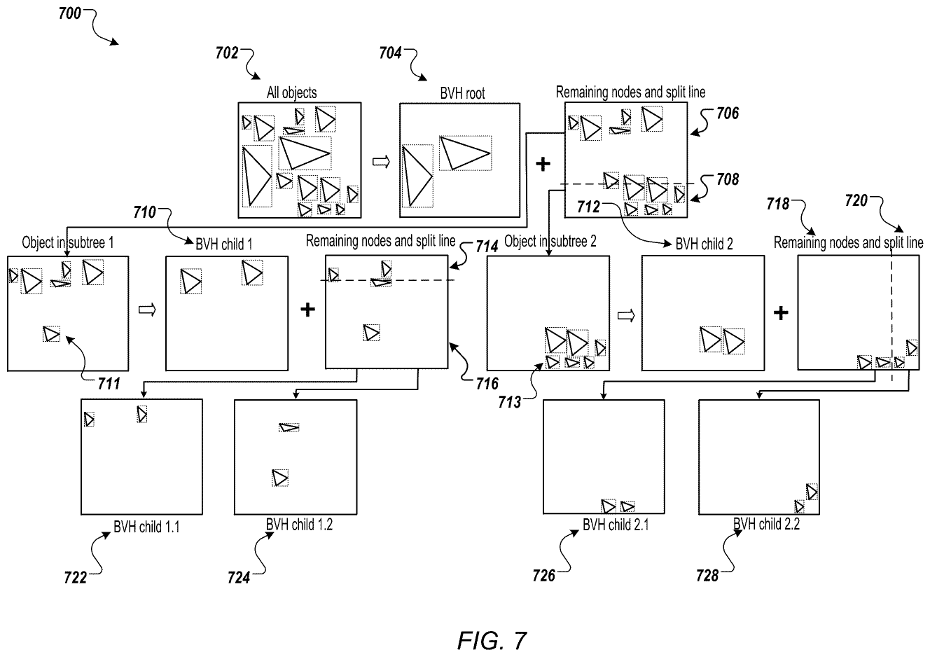

FIG. 7 shows an example illustration 700 of operations performed to build a BVH. For example, the BVH can correspond to the BVH 130 of FIG. 1. For example, the BVH 700 can be generated by a computer by performing the process 500 discussed above. As another example, the BVH 700 can be the BVH mentioned in FIG. 2.

The computer obtains a sorted list of a plurality of objects 702 in a 3D model of an environment. In the example of FIG. 7, the plurality of objects 702 includes fourteen objects. In other examples, however, the number of objects included in the root node 704 may range from two objects to tens of thousands, millions of objects, or billions of objects, or more.

The computer determines a root node cut-off diameter as a fraction of the size of the object that has the largest size among the plurality of objects 702, and generates a root node 704 of the BVH. The root node 704 corresponds to a root node bounding volume that encloses one or more objects of the plurality of objects 702. The one or more objects enclosed in the root node bounding volume are determined by selecting objects from the order list in accordance with their order (starting from the first that is the largest) to fit into the root node cut-off diameter. In practice the root node 704 of the BVH can be generated by the computer at operation 530 of the part of the process 500 described with reference to FIG. 5.

The exact number of the nodes to be enclosed by the root node bounding volume is dependent on the root node cut-off diameter. In the example of FIG. 7, the root node 704 includes two objects. In other examples, however, the number of objects included in the root node 704 may range from two objects to hundreds of objects, thousands of objects, or more.

The computer determines a child node cut-off diameter as a fraction of the size of the object that has the third largest size among the plurality of objects 702. The determination of the child node cut-off diameter can be performed as described in relation to 540 of FIG. 6. The child node cut-off diameter is determined based on the third largest object because the first two largest objects are now enclosed by the root node bounding volume that corresponds to the root node 704 generated by the computer, as shown in FIG. 7. In addition, the computer determines that, a dimension of a bounding volume that encloses the remaining objects in the plurality of objects 702 that are included in the sorted list and that are not enclosed by the root node bounding volume, is greater than a threshold dimension.

The computer applies (e.g., at step 560 of the part of the process 500 described with reference to FIG. 6) a spatial splitting function (illustrated as the horizontal dashed line 707 in FIG. 7) along the longest dimension of the bounding volume to split, i.e., spatially partition, the bounding volume that encloses the remaining objects into two smaller partitions: a first (upper) partition 706 and a second (lower) partition 708. The first partition 706 includes a plurality of first remaining objects. The second partition 708 includes a plurality of second remaining objects. For example, in FIG. 7, the plurality of first (or second) remaining objects includes a total of six objects. In other examples, the plurality of first (or second) remaining objects might include a greater number, e.g., hundreds, thousands, or millions, of objects.

The computer generates a first (left) child node 710 of the BVH. The first child node 710 corresponds to a first child node bounding volume that encloses a subset of the plurality of first remaining objects. The exact number of the nodes to be included in the subset, and therefore, enclosed by the first child node bounding volume, is dependent on the child node cut-off diameter.

In various cases, however, not all of the plurality of first remaining objects will be included in the proper set. For example, in FIG. 7, the object 711 is among the plurality of first remaining objects, but is excluded from the subset, and hence not enclosed by the first child node bounding volume. In fact, because the object 711 is not included in the plurality of second remaining objects included in the second partition 708, the object 711 is not enclosed by both the first child node bounding volume and the second child node bounding volume. In other examples, a greater number, e.g., hundreds, thousands, or millions, of objects among the plurality of first remaining objects might be excluded from the subset.

The computer generates a second (right) child node 712 of the BVH. The second child node 712 corresponds to a second child node bounding volume that encloses a subset of the plurality of second remaining objects. Much like the first child node bounding volume, the exact number of the nodes to be included in the subset, and therefore, enclosed by the second child node bounding volume, is dependent on the child node cut-off diameter. In practice the first child node 710 and the second child node 712 of the BVH can be generated by the computer at steps 570 and 580, respectively, during the first iteration of the part of the process 500 described with reference to FIG. 6.

In various cases, however, not all of the plurality of second remaining objects will be included in the proper set. For example, in FIG. 7, the object 713 is among the plurality of second remaining objects, but is excluded from the subset, and hence not enclosed by the second child node bounding volume. In fact, because the object 713 is not included in the plurality of first remaining objects included in the first partition 706, the object 713 is not enclosed by both the first child node bounding volume and the second child node bounding volume. In other examples, a greater number, e.g., hundreds, thousands, or millions, of nodes among the plurality of second remaining objects might be excluded from the subset.

For each of the first child node 710 and the second child node 712, the computer determines another child node cut-off diameter as a fraction of the size of the object that has the seventh largest size among the plurality of objects 702. The other child node cut-off diameter is determined based on the seventh largest object because, as shown in FIG. 7, the first two largest objects are now enclosed by the root node bounding volume that corresponds to the root node 704 generated by the computer. On the other hand, the third through sixth largest objects are now enclosed by the first and second node bounding volumes that correspond respectively to the first and second child nodes 710, 712 generated by the computer. In addition, the computer determines that, a dimension of a bounding volume that encloses the further remaining objects in the plurality of objects 702 that are included in the sorted list and that are not enclosed by the root node bounding volume (or any child node bounding volume during subsequent iteration), is greater than the threshold dimension.

For the first child node 710, the computer applies a spatial splitting function (illustrated as the horizontal dashed line 715 in FIG. 7) along the longest dimension of the bounding volume to split, i.e., spatially partition, the bounding volume that encloses the remaining objects in the plurality of first remaining objects into two smaller partitions: a first (upper) partition 714 and a second (lower) partition 716. The first partition 714 includes a plurality of first further remaining objects. The second partition 716 includes a plurality of second further remaining objects.

The computer generates a first (left) child node 722 of the first child node 710 of the BVH. The first child node 722 corresponds to a first child node bounding volume that encloses the plurality of first further remaining objects. The exact number of the nodes to be included in the subset, and therefore, enclosed by the first child node bounding volume, is dependent on the other child node cut-off diameter.

The computer generates a second (right) child node 724 of the first child node 710 of the BVH. The second child node 724 corresponds to a second child node bounding volume that encloses the plurality of second further remaining objects. Much like the first child node bounding volume, the exact number of the nodes to be included in the subset, and therefore, enclosed by the second child node bounding volume, is dependent on the other child node cut-off diameter.

In the example of FIG. 7, because the other child node cut-off diameter is large enough in this particular example, each object in the plurality of first remaining objects can be enclosed by either the first child node bounding volume that correspond to the first child node 722, or the second child node bounding volume that correspond to the second child node 724. In practice first child node 722 and the second child node 724 of the BVH can be generated by the computer at operations 570 and 580, respectively, during the second iteration of the part of the process 500 described with reference to FIG. 6.

For the second child node 712, the computer applies a spatial splitting function (illustrated as the vertical dashed line 719 in FIG. 7) along the longest dimension of the bounding volume to split, i.e., spatially partition, the bounding volume that encloses the remaining objects in the plurality of second remaining objects into two smaller partitions: a first (left) partition 718 and a second (right) partition 720. The first partition 718 includes a plurality of first further remaining objects. The second partition 720 includes a plurality of second further remaining objects.

The computer generates a first (left) child node 726 of the second child node 712 of the BVH. The first child node 726 corresponds to a first child node bounding volume that encloses the plurality of first further remaining objects. The exact number of the nodes to be included in the subset, and therefore, enclosed by the first child node bounding volume, is dependent on the other child node cut-off diameter.

The computer generates a second (right) child node 728 of the second child node 712 of the BVH. The second child node 728 corresponds to a second child node bounding volume that encloses the plurality of second further remaining objects. Much like the first child node bounding volume, the exact number of the nodes to be included in the subset, and therefore, enclosed by the second child node bounding volume, is dependent on the other child node cut-off diameter.

In the example of FIG. 7, because the other child node cut-off diameter is large enough, each object in the plurality of second remaining objects is enclosed by either the first child node bounding volume that correspond to the first child node 726, or the second child node bounding volume that correspond to the second child node 728. In practice first child node 726 and the second child node 728 of the BVH can be generated by the computer at steps 570 and 580, respectively, during the third iteration of the part of the process 500 described with reference to FIG. 6.

Once generated, the BVH can be used in any of a variety of ways. For example, when generated by a computer, e.g., the computer 110 of FIG. 1, the computer can provide the BVH for presentation to a user on a display device, store the BVH in a memory for later use, or provide the BVH to another system for further processing. As another example, when generated by a platform, e.g., the platform 170 of FIG. 1, the platform can store the BVH in a data storage for later use, or provide the BVH to the computer over a data communication network, e.g., the network 140 of FIG. 1.

In some instances, the BVH can be used by the computer to facilitate the rendering of model data, e.g., the model data 164 of FIG. 1, stored on a platform, e.g., the platform 170 of FIG. 1, while a user operates the computer to navigate around and within a three-dimensional, 3D, model of an environment, e.g., the 3D model 162 of FIG. 1. The BVH is viewpoint independent. That is, the same BVH can be used by the computer every time the user moves into a new viewpoint within a 3D model to generate a rendered view of a scene of the 3D model that corresponds to the new viewpoint. In some implementations, the BVH can be used by the computer while performing the processes 200 and 300 as discussed above.

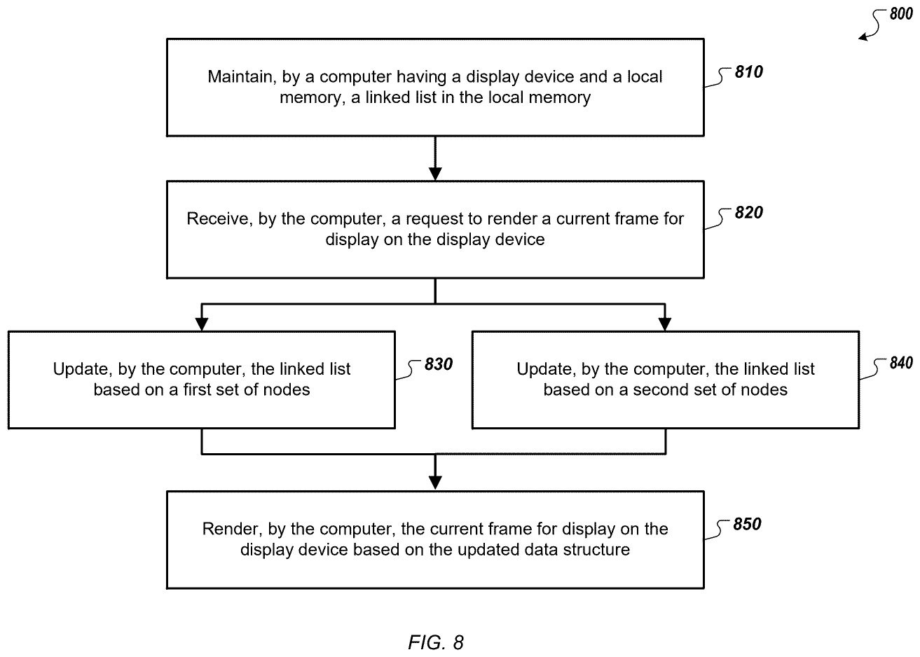

FIG. 8 shows an example of a process 800 for rendering a current frame for display on a display device in accordance with implementations of the present disclosure. In some implementations, the process 800 can be performed by a computer that has a display device and local memory, e.g., the computer 110 of FIG. 1, to facilitate the rendering of model data, e.g., the model data 164 of FIG. 1, stored on a platform, e.g., the platform 170 of FIG. 1, while a user operates the computer to navigate around and within a three-dimensional, 3D, model of an environment, e.g., the 3D model 162 of FIG. 1. For example, the 3D model can be a 3D model of a manufacturing site, building, physical construction, or another large-scale structure.

The 3D model can have a BVH generated for it. In some implementations, the BVH can correspond to the BVH 130 of FIG. 1. For example, the BVH can be built by the computer or the platform based on performing process 500 described above with reference to FIGS. 5-7. As another example, the BVH can be a different BVH that is obtained by the computer from a remote computer system.

The BVH is a data structure that includes nodes corresponding to one or more objects of a plurality of objects in the 3D model of the environment. The BVH can distribute the plurality of objects into the nodes into respective nodes of the BVH based on spatial partitioning of the 3D model (e.g., as described in relation to FIGS. 5, 6, and 7). That is, the BVH includes a plurality of nodes. Each node of the BVH corresponds to a bounding volume that encloses a different subset of the plurality of objects in the 3D model of the environment. Each subset includes at least one, but fewer than all, of the nodes of the BVH. The nodes of the BVH do not enclose overlapping subsets of the plurality of objects in the 3D model, and as such are distinct subsets.

In some implementations, the process 800 can be performed by the computer along with or as part of the process 200 described above with reference to FIG. 2 when traversing a BVH. For example, the process 800 can be performed as sub-operations of the operation 260 of the process 200.

In some implementations, the process 800 can be performed by the computer along with or as part of another algorithm or process for traversing a BVH of a 3D model to generate a queue data structure that can be used to initialize a list data structure to be maintain in the local memory of the computer and used to render objects of the 3D model, In principle the algorithm or process can be any appropriate BVH traversal algorithm or process, including algorithms that leverage the parallel processing capabilities of modern computing hardware, such as central processing units (CPUs), graphics processing units (GPUs), Field Programmable Gate Arrays (FGPAs), and Application Specific Integrated Circuits (ASICs), to improve the speed of the traversal of the BVH, e.g., for real time rendering.

At 810, a linked list is maintained by the computed in the local memory. That is, the computer has allocated space in the local memory for a linked list. For example, when performed as part of the process 200 of FIG. 2, the linked list has been initiated at operation 250 of the process 200 in the local memory of the computer.

The linked list is used to store a subset of the nodes of the BVH. The nodes of the BVH correspond to the plurality of objects in the 3D model of the environment. For example, when performed as part of the process 200, the linked list stores the nodes of the priority queue which, in turn, stores at least some the nodes of the BVH. As another example, the linked list can store one or more nodes obtained directly from the BVH.

At 820, a request to render a current frame for display on the display device is received by the computer. For example, the computer can obtain an indication that the user has changed to a current viewpoint within the environment as the user moves within the environment. In association with or as part of such an indication, the computer receives the request to render a current frame for display on the display device.

The current frame includes a rendered view of a scene of the 3D model that corresponds to the current viewpoint. For example, the current frame can include a rendered view of objects (“visible objects”) in the 3D model that are visible from the current viewpoint of the user. The visible objects include two different sets of objects that correspond respectively to two different, non-overlapping sets of nodes of the BVH: a first set of nodes and a second set of nodes.

The first set of nodes include nodes i) that corresponds to the visible objects in the 3D model that are included in the current frame, and ii) that are already included in the linked list. For example, a node might be included in the linked list because it corresponds to a visible object that was included in a previous frame that has already been rendered by the computer for display on the display device.

The second set of nodes include nodes i) that corresponds to the visible objects in the 3D model that are included in the current frame, but ii) that are not included in the linked list. For example, a node might not be included in the linked list because it corresponds to an object that was not visible in any previous frame that has already been rendered by the computer for display on the display device.

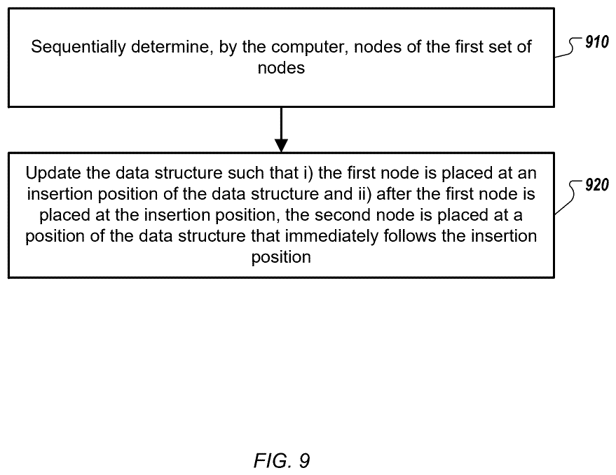

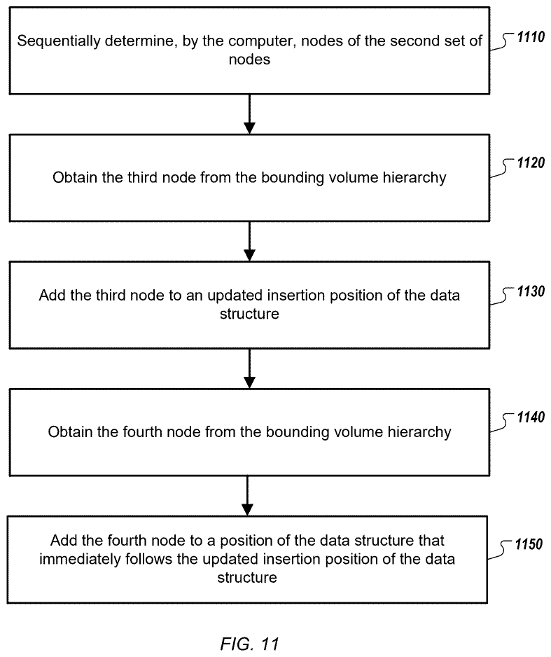

At 830, the linked list is updated by the computer based on the first set of nodes. Operation 830 includes sub-operations 910-920, as discussed below with reference to FIG. 9. At 840, the linked list is updated by the computer based on the second set of nodes. Operation 840 includes sub-operations 1110-1150, as discussed below with reference to FIG. 11. In some implementations, operations 830 and 840 are performed by a main thread that executes on a processor of the computer. For example, the main thread can correspond to the main thread 141 of FIG. 1.

In some implementations, updating the linked list involves removing one or more existing nodes from the linked list according to a removal criterion so that the linked list can maintain other new nodes that may be needed for the rendering. In some instances, the one or more existing nodes to be removed from the linked list that are to be removed can be selected from nodes at the end of the linked list as those are associated with lower likelihoods of being needed for the rendering again. The new nodes can be added to the linked list during iterations of operation 840. For example, the computer may have allocated a space in the local memory that has a fixed size for the linked list, and if so, the nodes that are least likely to be needed again, based on various removal criteria (e.g., the time since the most recent frame in which objects corresponding to the nodes were rendered, the frequency of frames within a period of time in which the objects corresponding to the nodes are rendered, or the like), can be deleted to provide space for storing new nodes as they are being determined as visible from the current viewpoint of the user. For example, in response to determining that a size of the linked list exceeds a size limit, the computer can delete one or more nodes that are located at one or more ending positions of the linked list from the linked list.

Although FIG. 8 illustrates that operation 830 is performed in parallel with operation 840, in practice, the computer can alternate between performing multiple iterations of the operation 830 and performing multiple iterations of the operation 840 as part of the process 800. That is, operation 830 and operation 840 can each be repeated any number of times, in any order, as part of the process 800.

Turning now to FIG. 9, which shows an example of sub-operations 910-920 of operation 830 of FIG. 8. At 910, nodes of the first set of nodes are sequentially determined by the computer. In general, the nodes of the first set of nodes are determined one after another as the objects corresponding to these nodes are determined to be visible from the current viewpoint of the user. For example, when performed as part of the process 200, the order in which the nodes of the first set of nodes are sequentially determined can, in turn, be the same as the order in which the nodes have been added to the priority queue. As another example, the order in which the nodes of the first set of nodes are sequentially determined can be dependent on the exact algorithm or process used by the computer to traverse the BVH. When a traversal algorithm is implemented and used to determine which objects of a 3D model are visible from a current viewpoint of the user in a 3D space, such a BVH traversal algorithm typically begins with largest object(s) enclosed by the root node bounding volume represented by the root node of the BVH, and proceeds progressively to the smaller object(s) enclosed by the child node bounding volumes represented by the child nodes of the root node of the BVH, i.e., through the intermediate nodes to leaf nodes.

In some instances, the first set of nodes can be determined to include a first node and a second node. The second node is determined after the first node. For example, when performed as part of the process 200, the first node was added to the priority queue prior to the second node, and, since the nodes in the priority queue are added to the linked list in a first-in-first-out order, the first node is determined prior to the second node among the first set of nodes.

At 920, in response to the determining the nodes of the first set of nodes, the linked list is updated by the computer such that i) the first node is placed at an insertion position of the linked list and ii) after the first node is placed at the insertion position, the second node that is determined after the first node is placed at a position of the data structure that immediately follows the insertion position. The insertion can be any position of the linked list. In particular, the computer sets the insertion position of the data structure to be same as the beginning position of the linked list whenever a request to render a frame for display on the display device is received. Thus, for the very first node that is determined among the first and second sets of nodes, the insertion position at which the very first node will be placed can be the beginning position of the linked list. Then, the insertion position is updated to shift rightward, one node by one node, as additional nodes are inserted into the linked list after the beginning position of the linked list.

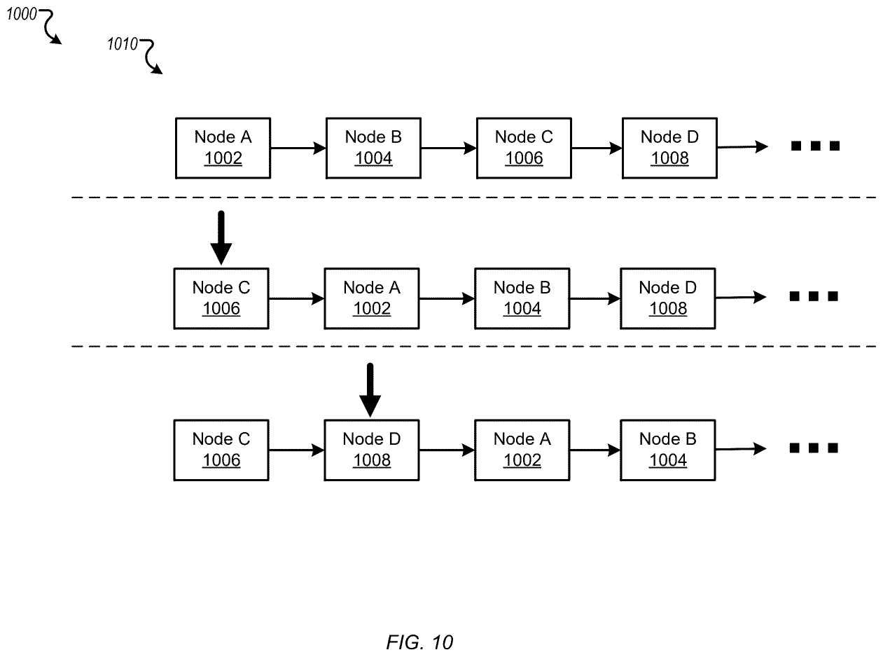

FIG. 10 shows an example illustration 1000 of operations performed to update a linked list 1010 in accordance with implementations of the present disclosure. As shown, the linked list 1010 is a data structure that includes a collection of nodes of the BVH that represents a sequence and, for each node, a link to the next node in the sequence. In this manner, each node (expect for the last node) in the linked list points to at least one other node in the list.

As illustrated in the top row of FIG. 10, the linked list 1010 stores node A 1002, node B 1004, node C 1006, and node D 1008, where node A 1002 points to node B 1004, which points to node C 1006, which points to node D 1008. Although a total of 4 nodes are shown in FIG. 10 for convenience, in general the linked list 1010 can include many more nodes, e.g., thousands, millions, or billions of nodes.

As illustrated in the middle row of FIG. 10, when a request to render a frame for display on the display device is received, the insertion position (illustrated as the downward pointing arrow) of the linked list 1010 is set to be the beginning position of the linked list 1010. Suppose that, in the example of FIG. 10, node C 1006 is the first node and node D 1008 is the second node that is determined after the first node.

Thus, as illustrated in the middle row of FIG. 10, after node C 1006 is determined to be a node that is included in linked list and that is associated with the current frame, the computer updates the linked list 1010 to move node C 1006 from an original position (the third position, in the example of FIG. 10) of the linked list 1010 that was occupied by node C 1006, to the insertion position (the beginning position) of the linked list 1010 at which node C 1006 is now placed. Correspondingly, the insertion position is updated to shift rightward by one position to the second position of the linked list 1010 where a subsequent node that is to be added to the linked list is to be placed, as illustrated in the bottom row of FIG. 10 where node D 1008 is added as a subsequent node to node C 1006.

As illustrated in the bottom row of FIG. 10, after node D 1008 is determined to be also in the linked list and associated with the current frame, the computer updates the linked list 1010 to move node D 1008 from an original position (the fourth position, in the example of FIG. 10) of the linked list 1010 that was occupied by node D 1008, to the insertion position (the second position that immediately follows the beginning position) of the linked list 1010 at which the node D 1008 is now placed.

It will be appreciated that, updating the linked list in this manner based on nodes that were already included in the linked list is different from how a linked list would be conventionally updated in response to receiving a request to render a current frame for display on the display device. For example, some cache populating algorithm might always place a node at the beginning position of the linked list. For example, referring back to the examples above discussed with reference to FIG. 10, another cache populating algorithm could place node D 1008 in a position preceding to node C 1006, once node D 1008 is determined after node C 1006 when traversing the BVH. In some cases, updating the linked list in this manner conserves the computational resources that would be required by such a cache populating algorithm because fewer updates to the linked list need to be made.

Turning now to FIG. 11, which shows an example of sub-operations 1110-1150 of operation 840 of FIG. 8. At 1110, nodes of the second set of current nodes are sequentially determined by the computer. Much like the first set of nodes, in general, the nodes of the second set of nodes are determined one after another as the objects corresponding to these nodes are determined to be visible from the current viewpoint of the user. For example, when performed as part of the process 200, the order in which the nodes of the second set of nodes are sequentially determined can, in turn, be the same as the order in which the nodes have been added to the priority queue, e.g., the queue data structure that is generated during the traversal of the BVH at 230 of FIG. 2.

As another example, the order in which the nodes of the second set of nodes are sequentially determined can be dependent on the exact algorithm or process used by the computer to traverse the BVH, the sizes of the objects, and so on. When used to determine which objects are visible from the current viewpoint of the user, such a BVH traversal algorithm can begin with largest object(s) enclosed by the root node bounding volume represented by the root node of the BVH, and proceeds progressively to the smaller object(s) enclosed by the child node bounding volumes represented by the child nodes of the root node of the BVH, i.e., through the intermediate nodes to leaf nodes. In some instances, the BVH and the BVH traversal algorithm can be the BVH and the BVH traversal algorithm, respectively, described with reference to FIGS. 2 and 3.

The second set of current nodes includes a third node and a fourth node. The fourth node is determined after the first node. For example, when performed as part of the process 200, the third node was added to the priority queue prior to the fourth node, and, since the nodes in the priority queue are added to the linked list in a first-in-first-out order, the third node is determined prior to the fourth node among the second set of nodes.

At 1120, in response to the determining, the third node is obtained by the computer from the BVH. For example, when performed as part of the process 200, the third node can be obtained by the computer from the BVH through the priority queue, for example, when initializing the list data structure at 250. In some cases, the BVH is stored in the local memory of the computer. In these cases, the computer can obtain the third node from the local memory of the computer at which the BVH is stored. In other cases, the BVH is stored on a remote computer system, for example, at a platform such as the platform 170 of FIG. 1. In these other cases, the computer can obtain the third node from the remote computer system, e.g., from the platform 170, at which the BVH is stored, over a network, e.g., the network 140 of FIG. 1.

At 1130, the linked list is updated by the computer such that the third node is added to the linked list and placed at an insertion position of the linked list. In particular, the third node is a new node that was previously not included in the linked list.

The insertion position can be any position of the linked list. In some instances, the computer can set the insertion position of the data structure to be same as the beginning position of the linked list whenever a request to render a frame for display on the display device is received. Then, the insertion position is updated to shift rightward, one node by one node, as additional nodes are inserted into the linked list after the beginning position of the linked list.

At 1140, the fourth node is obtained by the computer from the BVH. For example, when performed as part of the process 200, the fourth node can be obtained by the computer from the BVH through the priority queue. Much like the third node, in some cases, the BVH is stored in the local memory of the computer. In these cases, the computer can obtain the fourth node from the local memory of the computer at which the BVH is stored. In other cases, the BVH is stored on a remote computer system, for example, at a platform such as the platform 170 of FIG. 1. In these other cases, the computer can obtain the fourth node from the remote computer system, e.g., from the platform 170, at which the BVH is stored, over a network, e.g., the network 140 of FIG. 1.

At 1150, the linked list is updated by the computer such that the fourth node, which is determined and obtained after the third node, is added to the linked list and placed at a position of the linked list that immediately follows the insertion position of the linked list. In particular, the fourth node is a new node that was previously not included in the linked list.

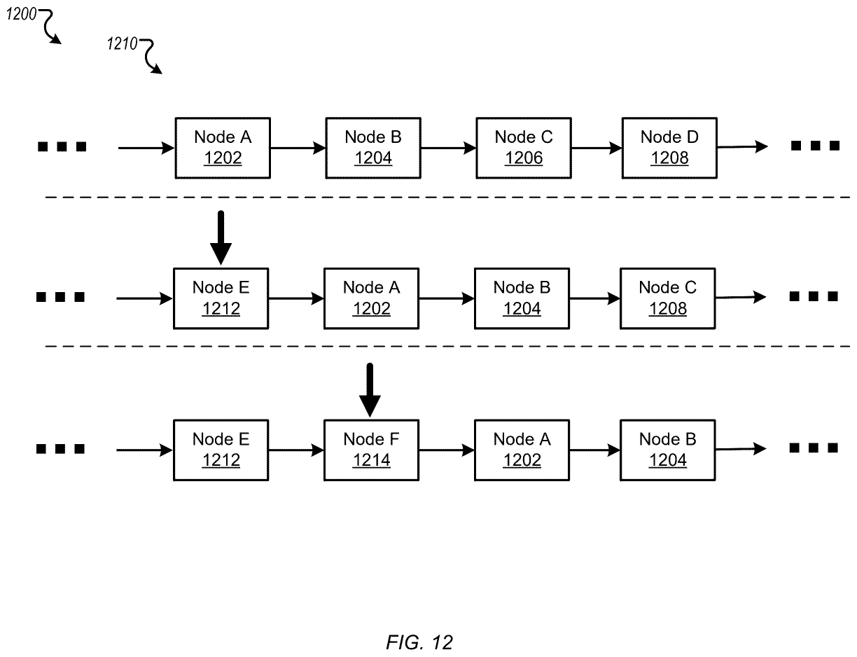

FIG. 12 shows another example illustration 1200 of operations performed to update a linked list 1210 in accordance with implementations of the present disclosure. As shown, the linked list 1210 is a data structure that includes a collection of nodes of a BVH that represents a sequence and, each node includes a link to the next node in the sequence. In this manner, each node in the linked list points to at least one other node in the list. In some instances, the BVH can be such as the BVH 130 of FIG. 1, or can be obtained as described with reference to FIGS. 5, 6, and 7.

As illustrated in the top row of FIG. 12, the linked list 1210 stores node A 1202, node B 1204, node C 1206, and node D 1208, where node A 1202 points to node B 1204, which points to node C 1206, which points to node D 1208. Although a total of 4 nodes are shown in FIG. 12 for convenience, in general the linked list 1210 can include many more nodes, e.g., thousands, millions, or billions of nodes, either before node A 1202 or after node D 1208 or both.

Suppose that, in the example of FIG. 12, node E 1212 is the third node and node F 1214 is the fourth node that is determined for inclusion in the list after the third node. Thus, as illustrated in the middle row of FIG. 12, after node E 1212 is determined for inclusion in the list, the computer obtains node E 1212 from the BVH (which is available locally or remotely) and then updates the linked list 1210 to add node E 1212 to the linked list 1210 by placing node E 1212 at the insertion position (the beginning position, in the example of FIG. 12) of the linked list 1210. Correspondingly, the insertion position is updated to shift rightward by one position to the second position of the linked list 1210, as illustrated in the bottom row of FIG. 12, so that when a subsequent node is to be added, the node is to be added in the updated (shifted) insertion position.

In particular, node E 1212 is a new node that was previously not included in the linked list 1210. Thus, adding node E 1212 to the linked list 1210 involves shifting existing nodes of the linked list, e.g., node A 1202, node B 1204, node C 1206, and node D 1208, which are already included in the linked list 1210 and are placed at positions subsequent to the insertion position, rightward by one position.

Next, as illustrated in the bottom row of FIG. 12, after node F 1214 is determined for inclusion in the list, the computer updates the linked list 1210 to add node F 1214 to the linked list 1210 by placing node F 1214 at the updated insertion position (the second position) of the linked list 1210. Much like node E 1212, node F 1214 is a new node that was previously not included in the linked list 1210. Thus, adding node F 1214 to the linked list 1210 involves shifting existing nodes of the linked list, e.g., node A 1202, node B 1204, node C 1206, node D 1208, which are already included in the linked list and are placed at positions subsequent to the insertion position, rightward by one position.

As previously mentioned, updating the linked list in this manner based on nodes that were previously not included in the linked list is different from how a linked list would be conventionally updated in response to receiving a request to render a current frame for display on the display device. For example, some cache populating algorithm might always obtain a new node and place the obtained node at the beginning position of the linked list. For example, referring back to the examples above discussed with reference to FIG. 12, another cache populating algorithm would place node F 1214 in a position preceding to node E 1212, once node F 1214 is determined and obtained after node E 1212 when traversing the BVH.

It will be understood that, although the terms first, second, third, fourth, etc. are used in the description of FIGS. 8-11 to describe various nodes, these nodes should not be limited by these terms. These terms are solely used to distinguish one node from another. In practice, there can be many more nodes, e.g., thousands, millions, or billions of nodes.

In such cases, the computer can repeat sub-operations 910-920 of operation 830 any of a number of times, to repeatedly update the linked list is updated by the computer based on any pair of nodes i) that correspond to the visible objects in the 3D model that are included in the current frame, and ii) that are already included in the linked list. Analogously, the computer can repeat sub-operations 1110-1150 of operation 840 any of a number of times, to repeatedly update the linked list is updated by the computer based on any pair of nodes i) that correspond to the visible objects in the 3D model that are included in the current frame, and ii) that are already included in the linked list.

In such cases, sub-operations 910-920 of operation 830 and sub-operations 1110-1150 of operation 840 can be interleaved within each other in any order. For example, an iteration of sub-operations 1110-1150 of operation 840 can follow an iteration of sub-operations 910-920 of operation 830; an iteration of sub-operations 1110-1150 of operation 840 can follow; an iteration of sub-operations 910-920 of operation 830 can follow another iteration of sub-operations 910-920 of operation 830; an iteration of sub-operations 1110-1150 of operation 840 can follow another iteration of sub-operations 1110-1150 of operation 840; and so forth.

Turning back to FIG. 8, at 850, the current frame is rendered by the computer for display on the display device based on the updated linked list. In general, the rendering of the current frame is based on the portion of the model data corresponding to the objects that correspond respectively to the nodes that are included in the updated linked list.

For example, the portion of the model data can include geometric primitives, e.g., triangles or rectangles, associated with these objects. The geometric primitive data can be rendered using any of a variety of computer graphics algorithm. For example, geometric primitive data can be rendered by using a ray tracing algorithm. As another example, geometric primitive data can be rendered by using a rasterization algorithm.

In some implementations, when updating the linked list at operation 840, the computer adds to each of the first and second nodes a tag that associates each of the first and second nodes to the current frame. Analogously, when updating the linked list at operation 850, the computer adds to each of the third and fourth nodes a tag that associates each of the third and fourth nodes to the current frame. In these implementations, operation 850 can be performed by rendering only the nodes (the “current nodes”) stored in the updated linked list that have tags that associate the nodes to the current frame, and not any other nodes stored in the updated linked list that do such tags that associate those other nodes to the current frame.

In some implementations, operation 850 is jointly performed by one or more worker threads and one or more loader threads that execute on the processor of the computer. In some implementations, the one or more worker threads can be part of a worker thread pool that includes a pool of worker threads. Analogously, in some implementations, the one or more loader threads can be part of a loader thread pool that includes a pool of loader threads. For example, the one or more worker threads can correspond to the one or more worker threads 142 of FIG. 1, and the one or more loader threads can correspond to the one or more loader threads 143 of FIG. 1.

In these implementations, at any time when performing operation 850, a worker thread can determine whether the geometric primitive data associated with an object, which corresponds to a node included in the updated linked list, is available in the local memory of the computer. The node can be any node included in the updated linked list, and the worker thread can be any thread in the pool of worker threads. For example, the computer can select an available worker thread in the pool of worker threads, and assign the selected worker thread to perform that determination. In response to determining that the geometric primitive data associated with the object is, in fact, not yet available in the local memory, the worker thread can send a request to a loader thread to download the geometric primitive data associated with the object to the local memory.

In response to the request, the loader thread downloads the geometric primitive data associated with the object to the local memory. For example, the loader thread can download the geometric primitive data from a remote computer system, e.g., from the platform 170, at which model data, e.g., model data 164, that corresponds to the BVH is stored, over a network, e.g., the network 140 of FIG. 1. The loader thread can be any thread in the pool of loader threads. For example, much like the worker thread, the computer can select an available loader thread in the pool of loader threads, and assign the selected loader thread to perform the download of the geometric primitive data.

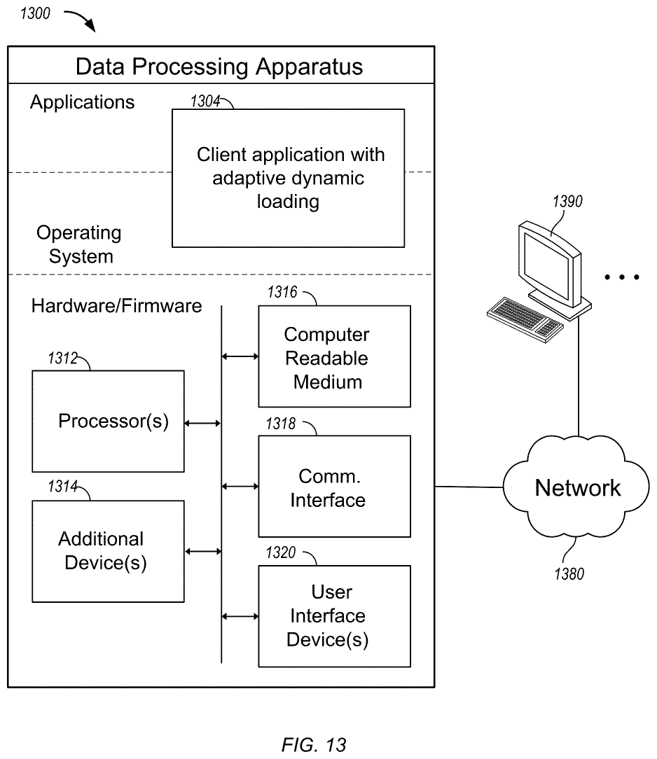

FIG. 13 is a schematic diagram of a data processing system including a data processing apparatus 1300, which can be programmed as a client or as a server. The data processing apparatus 1300 is connected with one or more computers 1390 through a network 1380. While only one computer is shown in FIG. 13 as the data processing apparatus 1300, multiple computers can be used. The data processing apparatus 1300 includes various software modules, which can be distributed between an applications layer and an operating system. These can include executable and/or interpretable software programs or libraries, including tools and services of a client application 1304 that includes a user interface that allows displaying of a 3D model of environments to a user of the client application 1304.

The number of software modules used can vary from one implementation to another. Moreover, the software modules can be distributed on one or more data processing apparatus connected by one or more computer networks or other suitable communication networks.

The data processing apparatus 1300 also includes hardware or firmware devices including one or more processors 1312, one or more additional devices 1314, a computer readable medium 1316, a communication interface 1318, and one or more user interface devices 1320. Each processor 1312 is capable of processing instructions for execution within the data processing apparatus 1300. In some implementations, the processor 1312 is a single or multi-threaded processor. Each processor 1312 is capable of processing instructions stored on the computer readable medium 1316 or on a storage device such as one of the additional devices 1314. The data processing apparatus 1300 uses the communication interface 1318 to communicate with one or more computers 1390, for example, over the network 1380. Examples of user interface devices 1320 include a display, a camera, a speaker, a microphone, a tactile feedback device, a keyboard, a mouse, and VR and/or AR equipment. The data processing apparatus 1300 can store instructions that implement operations associated with the program(s) described above, for example, on the computer readable medium 1316 or one or more additional devices 1314, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, e.g., after delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that produces an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing, and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other units suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors, executing one or more computer programs to perform functions by operating on input data and generating output. The processes and logic flows can also be performed by, and apparatus can also be implemented as, special purpose logic circuitry, e.g., a field programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read-only memory or a random access memory, or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a liquid crystal display (LCD) device, an organic light emitting diode (OLED) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other, and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a browser user interface, through which a user can interact with an implementation of the subject matter described in this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

### EXAMPLES

Although the present application is defined in the attached claims, it should be understood that the present invention can also (additionally or alternatively) be defined in accordance with the following examples:

Example 1. A computer-implemented method comprising:
obtaining, by a computer having a display device and a local memory, a bounding volume hierarchy including nodes corresponding to a plurality of objects in a three-dimensional, 3D, model of an environment, wherein the bounding volume hierarchy distributes the plurality of objects into the nodes based on spatial partitioning of the 3D model, and wherein objects of the nodes are ranked in a descending order of sizes from a root node of the bounding volume hierarchy to leaf nodes of the bounding volume hierarchy;
initiating, by the computer, a queue data structure in the local memory of the computer;
traversing, by the computer, the bounding volume hierarchy to add one or more nodes of the nodes of the bounding volume hierarchy to the queue data structure, wherein objects of the one or more nodes are to be rendered on the display device of the computer, and wherein the traversing of the bounding volume hierarchy stops when objects of one or more other nodes of the bounding volume hierarchy that are not yet added to the queue data structure (i) are not visible from a current viewpoint for a user within the environment or (ii) have screen space sizes that do not satisfy a predetermined threshold screen space size; and
rendering, by the computer, the objects of the one or more nodes on the display device.

Example 2. The method of Example 1, wherein rendering, by the computer, the objects of the one or more nodes on the display device comprises:
adding, by the computer, a first node of the queue data structure to a list data structure maintained in the local memory;
rendering, by the computer, an object of the first node on the display device; and removing, by the computer, the first node from the queue data structure.

Example 3. The method of Example 2, wherein rendering, by the computer, the object of the first node on the display device comprises:
obtaining, by the computer, from the local memory, a proper subset of the plurality of objects that correspond to the one or more nodes that are added to the queue data structure; and
rendering, by the computer, the proper subset of the plurality of objects from the local memory to the display device based the current viewpoint of the user within the environment.

Example 4. The method of Example 3, wherein obtaining, by the computer, the proper subset of the plurality of objects that correspond to the one or more nodes that are added to the queue data structure comprises:
downloading, by the computer, at least an object in the proper subset of the plurality of objects to the local memory.

Example 5. The method of any one of Examples 2-4, wherein the traversing of the bounding volume hierarchy comprises:
stopping the traversal when model data of objects corresponding to the one or more nodes of the bounding volume hierarchy that have already been added to the queue data structure exceed a predetermined threshold size.

Example 6. The method of any one of the preceding Examples, wherein the queue data structure is a priority queue data structure, and wherein adding the one or more nodes of the nodes of the bounding volume hierarchy to the queue data structure comprises storing each of the one or more nodes in association with a corresponding priority that is dependent on a screen space size of an object of the node.

Example 7. The method of any one of the preceding Examples, wherein traversing the bounding volume hierarchy across a plurality of iterations comprises, at an initial iteration of the plurality of iterations:
adding a root node of the bounding volume hierarchy into the queue data structure.

Example 8. The method of Example 7, wherein traversing the bounding volume hierarchy across the plurality of iterations comprises, at a subsequent iteration that immediately follows the initial iteration comprises:
determining whether a child node of the root node of the bounding volume hierarchy (i) is visible from the current viewpoint and (ii) has a screen space sizes that satisfies the predetermined threshold screen space size; and
in response to determining that the child node (i) is visible from the current viewpoint and (ii) has the screen space sizes that satisfies the predetermined threshold screen space size, adding the child node into the queue data structure.

Example 9. The method of any one of the preceding Examples, further comprising:
obtaining an indication that user has changed to a new viewpoint within the environment different from the current viewpoint; and
in response to obtaining the indication,
   initiating, by the computer, a new queue data structure in the local memory of the computer; and
   traversing the bounding volume hierarchy to add different nodes of the bounding volume hierarchy to the new queue data structure.

Example 10. A computer-implemented method for building a bounding volume hierarchy, wherein the method comprises:
obtaining, by a computer, a sorted list of a plurality of objects in a three-dimensional, 3D, model of an environment, wherein the sorted list includes the plurality of objects in descending order of sizes;
determining, by the computer, a root node cut-off diameter based on one or more objects included in the sorted list;
generating, by the computer, a root node of the bounding volume hierarchy, the root node corresponding to a root node bounding volume enclosing one or more objects that are located in one or more beginning positions of the sorted list, wherein a number of the one or more objects enclosed in the root node bounding volume is dependent on the root node cut-off diameter;
determining, by the computer, a child node cut-off diameter based on remaining objects in the plurality of objects that are included in the sorted list and that are not enclosed by the root node bounding volume; and
generating, by the computer, one or more child nodes of the root node to be included in the bounding volume hierarchy, wherein each of the one or more child nodes corresponds to a child node bounding volume enclosing one or more objects that is determined from the remaining objects in the plurality of objects in the 3D model based on applying a spatial splitting function, wherein a number of the one or more objects enclosed in each child node bounding volume is dependent on the child node cut-off diameter.

Example 11. The method of Example 10, wherein generating, by the computer, the one or more child nodes comprises:
applying the spatial splitting function to split the remaining objects into a first partition comprising a plurality of first remaining objects and a second partition comprising a plurality of second remaining objects;
generating a first child node of the bounding volume hierarchy, the first child node corresponding to a first child node bounding volume enclosing one or more of the plurality of first remaining objects, wherein a number of the one or more of the plurality of first remaining objects is dependent on the child node cut-off diameter; and
generating a second child node of the bounding volume hierarchy, the second child node corresponding to a second child node bounding volume enclosing one or more of the plurality of second remaining objects, wherein a number of the one or more of the plurality of second remaining objects is dependent on the child node cut-off diameter.

Example 12. The method of any one of Examples 10-11, further comprising:
determining, by the computer, a dimension of a bounding volume enclosing further remaining objects in the plurality of objects that are included in the sorted list and that are not enclosed by the root node bounding volume or the child node bounding volumes;
determining that the dimension is less than a threshold dimension; and
in response to determining that the dimension is less than the threshold dimension, generating a leaf node corresponding to a leaf node bounding volume enclosing the further remaining objects.

Example 13. The method of Example 12, wherein the dimension of the bounding volume is a diagonal dimension of the bounding volume.

Example 14. The method of any one of Examples 10-13, wherein obtaining the sorted list comprises:
obtaining, by a computer, a plurality of objects in a three-dimensional, 3D, model of the environment; and
sorting the plurality of objects to generate the sorted list that includes the plurality of objects in descending order of sizes.

Example 15. The method of any one of Examples 10-14, wherein the root node cut-off diameter is a fraction of a size of an object located in a beginning position of the sorted list.

Example 16. The method of any one of Examples 10-15, wherein the bounding volume hierarchy is independent of a current viewpoint of a user within the environment.

Example 17. A computer-implemented method comprising:
maintaining, by a computer having a display device and a local memory, a data structure in the local memory, the data structure storing nodes in a bounding volume hierarchy, the nodes corresponding to a plurality of objects in a three-dimensional, 3D, model of the environment;
receiving, by the computer, a request to render a current frame for display on the display device;
sequentially determining, by the computer, nodes of a first set of current nodes that are associated with the current frame and that are already included in the data structure, wherein the first set of current nodes comprises a first node and a second node that is determined after the first node;
in response to the determining, updating the data structure such that i) the first node is placed at an insertion position of the data structure and ii) after the first node is placed at the beginning position, the second node that is determined after the first node is placed at a position of the data structure that immediately follows the insertion position; and rendering, by the computer, the current frame for display on the display device based on the updated data structure.

Example 18. The method of Example 17, further comprising:
sequentially determining, by the computer, nodes of a second set of current nodes that are associated with the current frame and that are not included in the data structure, wherein the second set of current nodes comprise a third node and a fourth node that is determined after the third node;
in response to the determining, obtaining the third node from the bounding volume hierarchy;
adding the third node to an updated insertion position of the data structure;
obtaining the fourth node from the bounding volume hierarchy; and
   adding the fourth node that is determined after the third node to a position of the data structure that immediately follows the updated insertion position of the data structure.

Example 19. The method of Example 18, wherein the insertion position of the data structure is set to be same as the beginning position of the data structure whenever a request to render a frame for display on the display device is received.

Example 20. The method of any one of Examples 17-19, further comprising:
determining that a size of the data structure exceeds a size limit; and
in response, deleting one or more nodes that are located at one or more ending positions of the data structure from the data structure.

Example 21. The method of any one of Examples 18-20, wherein obtaining the third node from the bounding volume hierarchy comprises:
downloading, by the computer and from a remote computer system that stores the bounding volume hierarchy, the third node to the local memory.

Example 22. The method of any one of Examples 17-21, wherein updating the data structure comprises adding to the first node a tag that associates the first node to the current frame.

Example 23. The method of Example 22, wherein rendering the current frame for display on the display device based on the updated data structure comprises rendering nodes stored in the data structure that have tags that associate the nodes to the current frame.

Example 24. The method of any one of Examples 17-23, wherein the data structure comprises a list data structure.

Example 25. The method of any one of Examples 17-24, wherein updating the data structure comprises moving the first node from an original position of the data structure that was occupied by the first node to the insertion position of the data structure.

Example 26. The method of any one of Examples 17-25, wherein updating the data structure is performed by a main thread that executes at the computer.

Example 27. The method of any one of Examples 17-26, wherein rendering, by the computer, the current frame for display on the display device based on the updated data structure comprises:
determining, by one or more worker threads that execute at the computer, whether first geometric primitive data associated with an object that corresponds to the first node is available in the local memory; and
in response to determining that the first geometric primitive data associated with the object that corresponds to the first node is not available in the local memory, sending a request to one or more loader threads to download the first geometric primitive data associated with the object that corresponds to the first node to the local memory.

Example 28. The method of Example 27, further comprising:
downloading, by the one or more loader threads, the first geometric primitive data associated with the object that corresponds to the first node to the local memory.

Example 29. The method of any one of Examples 1-9, when also dependent on any one of Examples 10-16, wherein the bounding volume hierarchy is generated by performing the respective operations of any one of Examples 10-16.

Example 30. The method of any one of Examples 17-28, when also dependent on any one of Examples 1-9, wherein the bounding volume hierarchy is traversed by performing the respective operations of any one of Examples 1-9.

Example 31. The method of any one of Examples 17-28, when also dependent on any one of Examples 10-16, wherein the bounding volume hierarchy is generated by performing the respective operations of any one of Examples 10-16.

Similar operations and processes as described in Examples 1 to 31 can be performed in a system comprising at least one process and a memory communicatively coupled to the at least one processor where the memory stores instructions that when executed cause the at least one processor to perform the operations. Further, a non-transitory computer-readable medium storing instructions which, when executed, cause at least one processor to perform the operations as describes in any one of the Examples 1 to 31 can also be implemented.

What is claimed is:

1. A computer-implemented method comprising:
maintaining, by a computer having a display device and a local memory, a data structure in the local memory, the data structure storing nodes in a bounding volume hierarchy, the nodes corresponding to a plurality of objects in a three-dimensional, 3D, model of an environment;
receiving, by the computer, a request to render a current frame for display on the display device;
sequentially determining, by the computer, nodes of a first set of current nodes that are associated with the current frame and that are already included in the data structure, wherein the first set of current nodes comprises a first node and a second node that is determined after the first node;
in response to the determining, updating the data structure such that i) the first node is placed at an insertion position of the data structure and ii) after the first node is placed at the beginning position, the second node that is determined after the first node is placed at a position of the data structure that immediately follows the insertion position; and
rendering, by the computer, the current frame for display on the display device based on the updated data structure.

2. The method of claim 1, further comprising:
sequentially determining, by the computer, nodes of a second set of current nodes that are associated with the current frame and that are not included in the data structure, wherein the second set of current nodes comprise a third node and a fourth node that is determined after the third node;
in response to the determining, obtaining the third node from the bounding volume hierarchy;
adding the third node to an updated insertion position of the data structure;
obtaining the fourth node from the bounding volume hierarchy; and
adding the fourth node that is determined after the third node to a position of the data structure that immediately follows the updated insertion position of the data structure.

3. The method of claim 2, wherein the insertion position of the data structure is set to be same as the beginning position of the data structure whenever a request to render a frame for display on the display device is received.

4. The method of claim 1, further comprising:
determining that a size of the data structure exceeds a size limit; and
in response, deleting one or more nodes that are located at one or more ending positions of the data structure from the data structure.

5. The method of claim 2, wherein obtaining the third node from the bounding volume hierarchy comprises:
downloading, by the computer and from a remote computer system that stores the bounding volume hierarchy, the third node to the local memory.

6. The method of claim 1, wherein updating the data structure comprises adding to the first node a tag that associates the first node to the current frame.

7. The method of claim 6, wherein rendering the current frame for display on the display device based on the updated data structure comprises rendering nodes stored in the data structure that have tags that associate the nodes to the current frame.

8. The method of claim 1, wherein the data structure comprises a list data structure.

9. The method of claim 1, wherein updating the data structure comprises moving the first node from an original position of the data structure that was occupied by the first node to the insertion position of the data structure.

10. The method of claim 1, wherein updating the data structure is performed by a main thread that executes at the computer.

11. The method of claim 1, wherein rendering, by the computer, the current frame for display on the display device based on the updated data structure comprises:
determining, by one or more worker threads that execute at the computer, whether first geometric primitive data associated with an object that corresponds to the first node is available in the local memory; and
in response to determining that the first geometric primitive data associated with the object that corresponds to the first node is not available in the local memory, sending a request to one or more loader threads to download the first geometric primitive data associated with the object that corresponds to the first node to the local memory.

12. The method of claim 11, further comprising:
downloading, by the one or more loader threads, the first geometric primitive data associated with the object that corresponds to the first node to the local memory.

13. A system comprising:
one or more computers; and
one or more storage devices communicatively coupled to the one or more computers, wherein the one or more storage devices store instructions that, when executed by the one or more computers, cause the one or more computers to perform operations comprising:
maintaining, by a computer having a display device and a local memory, a data structure in the local memory, the data structure storing nodes in a bounding volume hierarchy, the nodes corresponding to a plurality of objects in a three-dimensional, 3D, model of an environment;
receiving, by the computer, a request to render a current frame for display on the display device;
sequentially determining, by the computer, nodes of a first set of current nodes that are associated with the current frame and that are already included in the data structure, wherein the first set of current nodes comprises a first node and a second node that is determined after the first node;
in response to the determining, updating the data structure such that i) the first node is placed at an insertion position of the data structure and ii) after the first node is placed at the beginning position, the second node that is determined after the first node is placed at a position of the data structure that immediately follows the insertion position; and
rendering, by the computer, the current frame for display on the display device based on the updated data structure.

14. The system of claim 13, wherein the operations further comprise:
sequentially determining, by the computer, nodes of a second set of current nodes that are associated with the current frame and that are not included in the data structure, wherein the second set of current nodes comprise a third node and a fourth node that is determined after the third node;
in response to the determining, obtaining the third node from the bounding volume hierarchy;
adding the third node to an updated insertion position of the data structure;
obtaining the fourth node from the bounding volume hierarchy; and
adding the fourth node that is determined after the third node to a position of the data structure that immediately follows the updated insertion position of the data structure.

15. The system of claim 14, wherein the insertion position of the data structure is set to be same as the beginning position of the data structure whenever a request to render a frame for display on the display device is received.

16. The system of claim 13, wherein the operations further comprise:
determining that a size of the data structure exceeds a size limit; and
in response, deleting one or more nodes that are located at one or more ending positions of the data structure from the data structure.

17. The system of claim 14, wherein obtaining the third node from the bounding volume hierarchy comprises:
downloading, by the computer and from a remote computer system that stores the bounding volume hierarchy, the third node to the local memory.

18. The system of claim 13, wherein updating the data structure comprises adding to the first node a tag that associates the first node to the current frame.

19. The system of claim 18, wherein rendering the current frame for display on the display device based on the updated data structure comprises rendering nodes stored in the data structure that have tags that associate the nodes to the current frame.

20. The system of claim 13, wherein the data structure comprises a list data structure.

21. The system of claim 13, wherein updating the data structure comprises moving the first node from an original position of the data structure that was occupied by the first node to the insertion position of the data structure.

22. The system of claim 13, wherein updating the data structure is performed by a main thread that executes at the computer.

23. One or more non-transitory computer storage media storing instructions that when executed by one or more computers cause the one or more computers to perform operations comprising:
maintaining, by a computer having a display device and a local memory, a data structure in the local memory, the data structure storing nodes in a bounding volume hierarchy, the nodes corresponding to a plurality of objects in a three-dimensional, 3D, model of an environment;
receiving, by the computer, a request to render a current frame for display on the display device;
sequentially determining, by the computer, nodes of a first set of current nodes that are associated with the current frame and that are already included in the data structure, wherein the first set of current nodes comprises a first node and a second node that is determined after the first node;
in response to the determining, updating the data structure such that i) the first node is placed at an insertion position of the data structure and ii) after the first node is placed at the beginning position, the second node that is determined after the first node is placed at a position of the data structure that immediately follows the insertion position; and
rendering, by the computer, the current frame for display on the display device based on the updated data structure.

24. The non-transitory computer storage media of claim 23, wherein the operations further comprise:
sequentially determining, by the computer, nodes of a second set of current nodes that are associated with the current frame and that are not included in the data structure, wherein the second set of current nodes comprise a third node and a fourth node that is determined after the third node;
in response to the determining, obtaining the third node from the bounding volume hierarchy;
adding the third node to an updated insertion position of the data structure;
obtaining the fourth node from the bounding volume hierarchy; and
adding the fourth node that is determined after the third node to a position of the data structure that immediately follows the updated insertion position of the data structure.

25. The non-transitory computer storage media of claim 24, wherein the insertion position of the data structure is set to be same as the beginning position of the data structure whenever a request to render a frame for display on the display device is received.

26. The non-transitory computer storage media of claim 23, wherein the operations further comprise:
determining that a size of the data structure exceeds a size limit; and
in response, deleting one or more nodes that are located at one or more ending positions of the data structure from the data structure.

27. The non-transitory computer storage media of claim 24, wherein obtaining the third node from the bounding volume hierarchy comprises:
downloading, by the computer and from a remote computer system that stores the bounding volume hierarchy, the third node to the local memory.

28. The non-transitory computer storage media of claim 23, wherein updating the data structure comprises adding to the first node a tag that associates the first node to the current frame.

29. The non-transitory computer storage media of claim 28, wherein rendering the current frame for display on the display device based on the updated data structure comprises rendering nodes stored in the data structure that have tags that associate the nodes to the current frame.

30. The non-transitory computer storage media of claim 23, wherein the data structure comprises a list data structure.
